(19) United States
(12) Patent Application Publication
(10) Pub. No.: US 2026/0320575 A1
(43) Pub. Date: Oct. 15, 2026

(54) SYSTEM AND METHOD FOR AUTHENTICATING AN AUTOMATED TELLER MACHINE SESSION

(71) Applicant: The Toronto-Dominion Bank, Toronto (CA)

(72) Inventors: Mohsen RAZA, Toronto (CA); Shahriar TAHERI, Newmarket (CA)

(73) Assignee: The Toronto-Dominion Bank, Toronto (CA)

(21) Appl. No.: 19/178,994

(22) Filed: Apr. 15, 2025

(51) Int. Cl. G06Q 20/10; G06Q 20/38; G07F 19/00

(52) U.S. Cl. CPC G06Q 20/1085; G06Q 20/3821; G07F 19/207

(57) ABSTRACT

A computer system comprises a communications module; at least one processor coupled with the communications module; and a memory coupled to the at least one processor and storing processor-executable instructions which, when executed by the at least one processor, configure the at least one processor to receive, via the communications module and from an automated teller machine, at least one signal that includes automated teller machine session data during an automated teller machine session; determine, based on the automated teller machine session data, that the automated teller machine session is high risk; and responsive to determining that the automated teller machine session is high risk, initiate authentication of the automated teller machine session using one-time password authentication.

### TECHNICAL FIELD

The present application relates to a system and method for authenticating an automated teller machine session.

### BACKGROUND

Automated teller machines are critical infrastructure for modern banking systems, enabling customers to perform various financial transactions with convenience. Automated teller machines are increasingly vulnerable to high-risk transactions, such as fraudulent withdrawals, account takeovers, and cash-out schemes. These risks arise from a combination of factors, including insufficient authentication mechanisms, compromised customer credentials, physical tampering, and sophisticated cyber-attacks.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified diagram showing components of an example automated teller machine;

FIG. 3 is a logical block diagram of the example automated teller machine of FIG. 2;

FIG. 4 is a high-level operation diagram of an example computing device;

FIG. 5 depicts an example simplified software organization of the example computing device of FIG. 4;

FIG. 6 is an example schematic diagram outlining various components of an artificial intelligence engine;

FIG. 7 is a flowchart showing operations performed in initiating second factor authentication;

FIG. 8 is a flowchart showing operating performed in identify verification through image-based biometrics;

FIG. 9 is a flowchart showing operations performed in verifying identity using image comparison;

FIG. 10 is a flowchart showing operations performed in sending a one-time password;

FIG. 11 is an example SMS message displayed on a display screen of a computing device;

FIG. 12 is a flowchart showing operations performed in identity verification using one-time password authentication;

FIG. 13 is an example message displayed on a display screen of an automated teller machine;

FIG. 14 is an example indication displayed on a display screen of an automated teller machine;

FIG. 15 is another example message displayed on a display screen of an automated teller machine;

FIG. 16 is an example reply message displayed on a display screen of a mobile device;

FIG. 17 is another example message displayed on a display screen of an automated teller machine;

FIG. 18 is a flowchart showing operations performed in identity verification using in-app biometric authentication;

FIG. 19 is another flowchart showing operations performed in identity verification using in-app biometric authentication;

FIG. 20 is a notification displayed on a display screen of an automated teller machine;

FIG. 21 is another flowchart showing operations performed in initiating second factor authentication; and

FIG. 22 is yet another flowchart showing operations performed in initiating second factor authentication.

Like reference numerals are used in the drawings to denote like elements and features.

### DETAILED DESCRIPTION OF VARIOUS EMBODIMENTS

Accordingly, in one aspect there is provided a computer system comprising a communications module; at least one processor coupled with the communications module; and a memory coupled to the at least one processor and storing processor-executable instructions which, when executed by the at least one processor, configure the at least one processor to receive, via the communications module and from an automated teller machine, at least one signal that includes automated teller machine session data during an automated teller machine session; determine, based on the automated teller machine session data, that the automated teller machine session is high risk; responsive to determining that the automated teller machine session is high risk, initiate capture of biometric data; and initiate analysis of the biometric data to authenticate the automated teller machine session.

In one or more embodiments, the instructions, when executed, further configure the at least one processor to responsive to authenticating the automated teller machine session, authorize at least one function during the automated teller machine session.

In one or more embodiments, the at least one function includes initiating the automated teller machine session or authorizing a transaction requested during the automated teller machine session.

In one or more embodiments, when initiating the capture of the biometric data, the instructions, when executed, further configure the at least one processor to send, via the communications module, at least one signal to initiate the capture of the biometric data; and receive, via the communications module, at least one signal that includes the biometric data.

In one or more embodiments, the at least one signal to initiate the capture of the biometric data is sent to an imaging device associated with the automated teller machine.

In one or more embodiments, the analysis of the biometric data to authenticate the automated teller machine session is performed as a second factor authentication during the automated teller machine session only when the automated teller machine session is determined to be high risk.

In one or more embodiments, when analyzing the biometric data, the instructions, when executed by the at least one processor, further configure the at least one processor to obtain previously verified biometric data from a database; generate a similarity score at least by comparing the biometric data to the previously verified biometric data; and compare the similarity score to a threshold to authenticate the automated teller machine session.

In one or more embodiments, when determining that the automated teller machine session is high risk, the instructions, when executed by the at least one processor, further configure the at least one processor to analyze the automated teller machine session data at least to determine that the automated teller machine is located in an area known to be high risk.

In one or more embodiments, when determining that the automated teller machine session is high risk, the instructions, when executed by the at least one processor, further configure the at least one processor to analyze the automated teller machine session data at least to identify an automated teller machine risk score indicating that the automated teller machine is high risk.

In one or more embodiments, when determining that the automated teller machine session is high risk, the instructions, when executed by the at least one processor, further configure the at least one processor to analyze the automated teller machine session data at least to determine that a time of the automated teller machine session is high risk.

In one or more embodiments, when determining that the automated teller machine session is high risk, the instructions, when executed by the at least one processor, further configure the at least one processor to analyze the automated teller machine session data at least to identify a withdrawal amount requested during the automated teller machine session; and determine, at least based on the withdrawal amount, that the automated teller machine session is high risk.

In one or more embodiments, the instructions, when executed, further configure the at least one processor to engage an artificial intelligence engine to analyze the automated teller machine session data to determine that the automated teller machine session is high risk.

In one or more embodiments, the biometric data includes image data.

According to another aspect there is provided a computer-implemented method comprising receiving, via a communications module and from an automated teller machine, at least one signal that includes automated teller machine session data during an automated teller machine session; determining, based on the automated teller machine session data, that the automated teller machine session is high risk; responsive to determining that the automated teller machine session is high risk, initiating capture of biometric data; and initiating analysis of the biometric data to authenticate the automated teller machine session.

In one or more embodiments, the method further comprises responsive to authenticating the automated teller machine session, authorizing at least one function during the automated teller machine session.

In one or more embodiments, the at least one function includes initiating the automated teller machine session or authorizing a transaction requested during the automated teller machine session.

In one or more embodiments, when initiating the capture of the biometric data, the method further comprises sending, via the communications module, at least one signal to initiate the capture of the biometric data; and receiving, via the communications module, at least one signal that includes the biometric data.

In one or more embodiments, the analysis of the biometric data to authenticate the automated teller machine session is performed as a second factor authentication during the automated teller machine session only when the automated teller machine session is determined to be high risk.

In one or more embodiments, when analyzing the biometric data, the method further comprises obtaining previously verified biometric data from a database; generating a similarity score at least by comparing the biometric data to the previously verified biometric data; and comparing the similarity score to a threshold to authenticate the automated teller machine session.

According to another aspect there is provided a non-transitory computer readable storage medium comprising computer-executable instructions which, when executed, configure at least one processor to receive, via a communications module and from an automated teller machine, at least one signal that includes automated teller machine session data during an automated teller machine session; determine, based on the automated teller machine session data, that the automated teller machine session is high risk; responsive to determining that the automated teller machine session is high risk, initiate capture of biometric data; and initiate analysis of the biometric data to authenticate the automated teller machine session.

According to another aspect there is provided a computer system comprising a communications module; at least one processor coupled with the communications module; and a memory coupled to the at least one processor and storing processor-executable instructions which, when executed by the at least one processor, configure the at least one processor to receive, via the communications module and from an automated teller machine, at least one signal that includes automated teller machine session data during an automated teller machine session; determine, based on the automated teller machine session data, that the automated teller machine session is high risk; and responsive to determining that the automated teller machine session is high risk, initiate authentication of the automated teller machine session using one-time password authentication.

In one or more embodiments, the instructions, when executed, further configure the at least one processor to, responsive to authenticating the automated teller machine session using the one-time password authentication, authorize at least one function during the automated teller machine session.

In one or more embodiments, the at least one function includes initiating the automated teller machine session or authorizing a transaction requested during the automated teller machine session.

In one or more embodiments, when initiating the authentication of the automated teller machine using the one-time password authentication, the instructions, when executed, further configure the at least one processor to generate a one-time password and associate the one-time password with the automated teller machine session.

In one or more embodiments, when initiating the authentication of the automated teller machine using the one-time password authentication, the instructions, when executed, further configure the at least one processor to determine, based at least on the automated teller machine session data, a digital address; and send, via the communications module and to the digital address, at least one signal that includes the one-time password.

In one or more embodiments, the one-time password is sent to the digital address via one of short message service message, electronic mail, or push notification.

In one or more embodiments, when initiating the authentication of the automated teller machine using the one-time password authentication, the instructions, when executed, further configure the at least one processor to send, via the communications module and to the automated teller machine, at least one signal causing the automated teller machine to display a message prompting input of a one-time password; receive, via the communications module and from the automated teller machine, at least one signal that includes a password entered using a keypad associated with the automated teller machine; and compare the password to the one-time password to authenticate the automated teller machine session.

In one or more embodiments, wherein the authentication of the automated teller machine using the one-time password authentication is performed as a second factor authentication during the automated teller machine session only when the automated teller machine session is determined to be high risk.

In one or more embodiments, when determining that the automated teller machine session is high risk, the instructions, when executed by the at least one processor, further configure the at least one processor to analyze the automated teller machine session data at least to determine that the automated teller machine is located in an area known to be high risk.

In one or more embodiments, when determining that the automated teller machine session is high risk, the instructions, when executed by the at least one processor, further configure the at least one processor to analyze the automated teller machine session data at least to identify an automated teller machine risk score indicating that the automated teller machine is high risk.

In one or more embodiments, when determining that the automated teller machine session is high risk, the instructions, when executed by the at least one processor, further configure the at least one processor to analyze the automated teller machine session data at least to determine that a time of the automated teller machine session is high risk.

In one or more embodiments, when determining that the automated teller machine session is high risk, the instructions, when executed by the at least one processor, further configure the at least one processor to analyze the automated teller machine session data at least to identify a withdrawal amount requested during the automated teller machine session; and determine, based at least on the withdrawal amount, that the automated teller machine session is high risk.

In one or more embodiments, the instructions, when executed, further configure the at least one processor to engage an artificial intelligence engine to analyze the automated teller machine session data to determine that the automated teller machine session is high risk.

According to another aspect there is provided a computer-implemented method comprising receiving, via a communications module and from an automated teller machine, at least one signal that includes automated teller machine session data during an automated teller machine session; determining, based on the automated teller machine session data, that the automated teller machine session is high risk; and responsive to determining that the automated teller machine session is high risk, initiating authentication of the automated teller machine session using one-time password authentication.

In one or more embodiments, the method further comprises responsive to authenticating the automated teller machine session using the one-time password authentication, authorizing at least one function during the automated teller machine session.

In one or more embodiments, the at least one function includes initiating the automated teller machine session or authorizing a transaction requested during the automated teller machine session.

In one or more embodiments, when initiating the authentication of the automated teller machine session using the one-time password authentication, the method further comprises generating a one-time password and associating the one-time password with the automated teller machine session.

In one or more embodiments, when initiating the authentication of the automated teller machine session using the one-time password authentication, the method further comprises determining, based at least on the automated teller machine session data, a digital address; and sending, via the communications module and to the digital address, at least one signal that includes the one-time password.

In one or more embodiments, when initiating the authentication of the automated teller machine session using the one-time password authentication, the method further comprises sending, via the communications module and to the automated teller machine, at least one signal causing the automated teller machine to display a message prompting input of a one-time password; receiving, via the communications module and from the automated teller machine, at least one signal that includes a password entered using a keypad associated with the automated teller machine; and comparing the password to the one-time password to authenticate the automated teller machine session.

According to another aspect there is provided a non-transitory computer readable storage medium comprising computer-executable instructions which, when executed, configure at least one processor to receive, via a communications module and from an automated teller machine, at least one signal that includes automated teller machine session data during an automated teller machine session; determine, based on the automated teller machine session data, that the automated teller machine session is high risk; and responsive to determining that the automated teller machine session is high risk, initiating authentication of the automated teller machine session using one-time password authentication.

According to another aspect there is provided a computer system comprising a communications module; at least one processor coupled with the communications module; and a memory coupled to the at least one processor and storing processor-executable instructions which, when executed by the at least one processor, configure the at least one processor to receive, via the communications module and from an automated teller machine, at least one signal that includes automated teller machine session data during an automated teller machine session; determine, based on the automated teller machine session data, that the automated teller machine session is high risk; and responsive to determining that the automated teller machine session is high risk, initiate authentication of the automated teller machine session via in-app biometric authentication.

In one or more embodiments, the instructions, when executed, further configure the at least one processor to, responsive to authenticating the automated teller machine via the in-app biometric authentication, authorize at least one function during the automated teller machine session.

In one or more embodiments, the at least one function includes initiating the automated teller machine session or authorizing a transaction requested during the automated teller machine session.

In one or more embodiments, wherein when initiating the authentication of the automated teller machine session via the in-app biometric authentication, the instructions, when executed, further configure the at least one processor to send, via the communications module and to the automated teller machine, at least one signal causing the automated teller machine to display a notification requesting the in-app biometric authentication.

In one or more embodiments, wherein when initiating the authentication of the automated teller machine session via the in-app biometric authentication, the instructions, when executed, further configure the at least one processor to receive, via the communications module and from a mobile device, at least one signal indicating successful authentication; analyze the at least one signal to determine that the successful authentication included biometric authentication; and responsive to determining that the successful authentication included biometric authentication, authenticate the automated teller machine session.

In one or more embodiments, wherein when initiating the authentication of the automated teller machine session via the in-app biometric authentication, the instructions, when executed, further configure the at least one processor to generate an automated teller machine session token associated with the automated teller machine session; send, via the communications module and to a mobile device, the automated teller machine session token; receive, via the communications module and from the mobile device, a signed automated teller machine session token; verify the signed automated teller machine session token; and responsive to verifying the signed automated teller machine session token, authenticate the automated teller machine session.

In one or more embodiments, when verifying the signed session token, the instructions, when executed, further configure the at least one processor to analyze the signed automated teller machine session token to determine an authentication method used for the in-app biometric authentication; determine that the authentication method includes biometric authentication; and in response to determining that the authentication method includes the biometric authentication, verify the signed session token.

In one or more embodiments, wherein the authentication of the automated teller machine session via the in-app biometric authentication is performed as a second factor authentication during the automated teller machine session only when the automated teller machine session is determined to be high risk.

In one or more embodiments, when determining that the automated teller machine session is high risk, the instructions, when executed by the at least one processor, further configure the at least one processor to analyze the automated teller machine session data at least to determine that the automated teller machine is located in an area known to be high risk.

In one or more embodiments, when determining that the automated teller machine session is high risk, the instructions, when executed by the at least one processor, further configure the at least one processor to analyze the automated teller machine session data at least to identify an automated teller machine risk score indicating that the automated teller machine is high risk.

In one or more embodiments, when determining that the automated teller machine session is high risk, the instructions, when executed by the at least one processor, further configure the at least one processor to analyze the automated teller machine session data at least to determine that a time of the automated teller machine session is high risk.

In one or more embodiments, when determining that the automated teller machine session is high risk, the instructions, when executed by the at least one processor, further configure the at least one processor to analyze the automated teller machine session data at least to identify a withdrawal amount requested during the automated teller machine session; and determine, based at least on the withdrawal amount, that the automated teller machine session is high risk.

In one or more embodiments, the instructions, when executed, further configure the at least one processor to engage an artificial intelligence engine to analyze the automated teller machine session data to determine that the automated teller machine session is high risk.

According to another aspect there is provided a computer-implemented method comprising receiving, via a communications module and from an automated teller machine, at least one signal that includes automated teller machine session data during an automated teller machine session; determining, based on the automated teller machine session data, that the automated teller machine session is high risk; and responsive to determining that the automated teller machine session is high risk, initiating authentication of the automated teller machine session via in-app biometric authentication.

In one or more embodiments, the method further comprises responsive to authenticating the automated teller machine via the in-app biometric authentication, authorizing at least one function during the automated teller machine session.

In one or more embodiments, the at least one function includes initiating the automated teller machine session or authorizing a transaction requested during the automated teller machine session.

In one or more embodiments, wherein when initiating the authentication of the automated teller machine session via the in-app biometric authentication, the method further comprises sending, via the communications module and to the automated teller machine, at least one signal causing the automated teller machine to display a notification requesting the in-app biometric authentication.

In one or more embodiments, wherein when initiating the authentication of the automated teller machine session via the in-app biometric authentication, the method further comprises receiving, via the communications module and from a mobile device, at least one signal indicating successful authentication; analyzing the at least one signal to determine that the successful authentication included biometric authentication; and responsive to determining that the successful authentication included biometric authentication, authenticating the automated teller machine session.

In one or more embodiments, wherein when initiating the authentication of the automated teller machine session via the in-app biometric authentication, the method further comprises generating an automated teller machine session token associated with the automated teller machine session; sending, via the communications module and to a mobile device, the automated teller machine session token; receiving, via the communications module and from the mobile device, a signed automated teller machine session token; verifying the signed automated teller machine session token; and responsive to verifying the signed automated teller machine session token, authenticating the automated teller machine session.

According to another aspect there is provided a non-transitory computer readable storage medium comprising computer-executable instructions which, when executed, configure at least one processor to receive, via a communications module and from an automated teller machine, at least one signal that includes automated teller machine session data during an automated teller machine session; determine, based on the automated teller machine session data, that the automated teller machine session is high risk; and responsive to determining that the automated teller machine session is high risk, initiate authentication of the automated teller machine session via in-app biometric authentication.

According to another aspect there is provided a computer system comprising a communications module; at least one processor coupled with the communications module; and a memory coupled to the at least one processor and storing processor-executable instructions which, when executed by the at least one processor, configure the at least one processor to train an artificial intelligence engine to generate risk scores for automated teller machine sessions; receive, via the communications module and from an automated teller machine, at least one signal that includes automated teller machine session data during an automated teller machine session; engage the artificial intelligence engine to determine that the automated teller machine session is high risk; and responsive to determining that the automated teller machine session is high risk, initiate second factor authentication.

In one or more embodiments, the artificial intelligence engine determines that the automated teller machine session is high risk based at least on the automated teller machine session data.

In one or more embodiments, the instructions, when executed, further configure the at least one processor to train the artificial intelligence engine to select a second factor authentication method based on at least one of automated teller machine session data and contextual data.

In one or more embodiments, the artificial intelligence engine is trained to select the second factor authentication method based on a specific context determined from the contextual data.

In one or more embodiments, the contextual data includes an indication that one or more devices are available for the second factor authentication.

In one or more embodiments, the one or more devices include an imaging device associated with the automated teller machine, a mobile device, a biometric sensing device associated with the mobile device, or a particular mobile application installed on the mobile device.

In one or more embodiments, the artificial intelligence engine is trained to prioritize selection of the second factor authentication method at least based on computer resource efficiency.

In one or more embodiments, the artificial intelligence engine is trained to select the second factor authentication method at least based on the risk score.

In one or more embodiments, the second factor authentication includes at least one of image-based biometric authentication, in-app biometric authentication, and one-time password authentication.

In one or more embodiments, the automated teller machine session is determined to be high risk at least based on transaction specific and real-time features.

In one or more embodiments, the transaction specific and real-time features include at least one of unusual withdrawal patterns, transaction timing, or anomalies in user behavior.

In one or more embodiments, the artificial intelligence engine is trained to generate a risk score for the automated teller machine session.

In one or more embodiments, the instructions, when executed, further configure the at least one processor to determine, based on the risk score, that the automated teller machine session is high risk.

In one or more embodiments, the artificial intelligence engine is trained to classify the automated teller machine session as high risk.

In one or more embodiments, the artificial intelligence engine is trained to classify an automated teller machine as high risk.

In one or more embodiments, the instructions, when executed, further configure the at least one processor to engage the artificial intelligence engine to classify the automated teller machine as high risk; and send, via the communications module and to the automated teller machine, at least one signal that includes an indication that the automated teller machine is high risk.

In one or more embodiments, the indication that the automated teller machine is high risk is stored in memory of the automated teller machine and is included in the automated teller machine session data for each automated teller machine session hosted by the automated teller machine.

According to another aspect there is provided a computer-implemented method comprising training an artificial intelligence engine to generate risk scores for automated teller machine sessions; receiving, via the communications module and from an automated teller machine, at least one signal that includes automated teller machine session data during an automated teller machine session; engaging the artificial intelligence engine to determine that the automated teller machine session is high risk; and responsive to determining that the automated teller machine session is high risk, initiating second factor authentication.

According to another aspect there is provided a non-transitory computer readable storage medium comprising computer-executable instructions which, when executed, configure at least one processor to train an artificial intelligence engine to generate risk scores for automated teller machine sessions; receive, via the communications module and from an automated teller machine, at least one signal that includes automated teller machine session data during an automated teller machine session; engage the artificial intelligence engine to determine that the automated teller machine session is high risk; and responsive to determining that the automated teller machine session is high risk, initiate second factor authentication.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

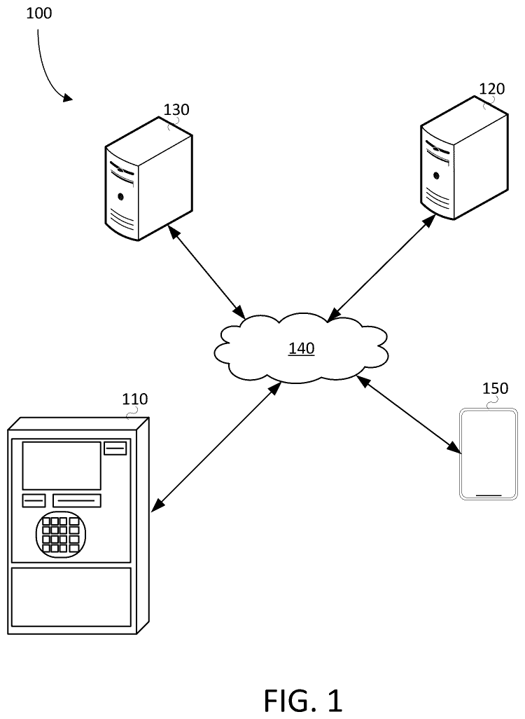

FIG. 1 is a schematic operation diagram illustrating an operating environment of an example embodiment. As shown, a system 100 includes an automated teller machine 110, an automated teller machine switch 120, and a server computer system 130 coupled to one another through a network 140, which may include a public network such as the Internet and/or a private network. The system 100 may also include a mobile device 150. The automated teller machine 110, the automated teller machine switch 120, the server computer system 130, and the mobile device 150 may be in geographically disparate locations. Put differently, the automated teller machine 110, the automated teller machine switch 120, the server computer system 130, and the mobile device 150 may be located remote from one another.

The automated teller machine 110 may be associated with a financial institution. The automated teller machine 110 is adapted to provide access to banking services such as, for example, withdrawals and deposits.

The automated teller machine switch 120 and the server computer system 130 are computer server systems. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The automated teller machine switch 120 may be adapted to broker (e.g., relay) communication between the automated teller machine 110 and a payment network (not shown). The automated teller machine switch 120 may perform operations related to performing transactions using the automated teller machine 110. For example, the automated teller machine switch 120 may perform operations related to authorizing and/or completing transactions based on cheques deposited at the automated teller machine 110. The automated teller machine switch 120 may additionally or alternatively perform operations related to authenticating a user of the automated teller machine 110. For example, the automated teller machine switch 120 may perform operations to authenticate a user based on data from a card used to access the automated teller machine 110 and based on a personal identification number (PIN) received as input by the automated teller machine 110.

The server computer system 130 may be associated with a financial institution and the financial institution may be the same financial institution associated with the automated teller machine 110. As will be described in more detail below, the server computer system 130 may include instructions to determine that an automated teller machine session is high risk and in response may perform operations associated with second factor authentication. In one or more embodiments, the server computer system 130 may include an artificial intelligence engine trained to assess automated teller machine risk and/or automated teller machine session risk.

The network 140 is a computer network. In some embodiments, the network 140 may be an internetwork such as may be formed of one or more interconnected computer networks. For example, the network 140 may be or may include an Ethernet network, an asynchronous transfer mode network, a wireless network, a telecommunications network, or the like.

The mobile device 150 may take a variety of forms including, for example, a mobile communication device such as a smartphone, a tablet computer, a wearable computer (such as a head-mounted display or smartwatch), or a computing device of another type. The mobile device 150 may store software instructions that cause the mobile device 150 to establish communications with the server computer system 130.

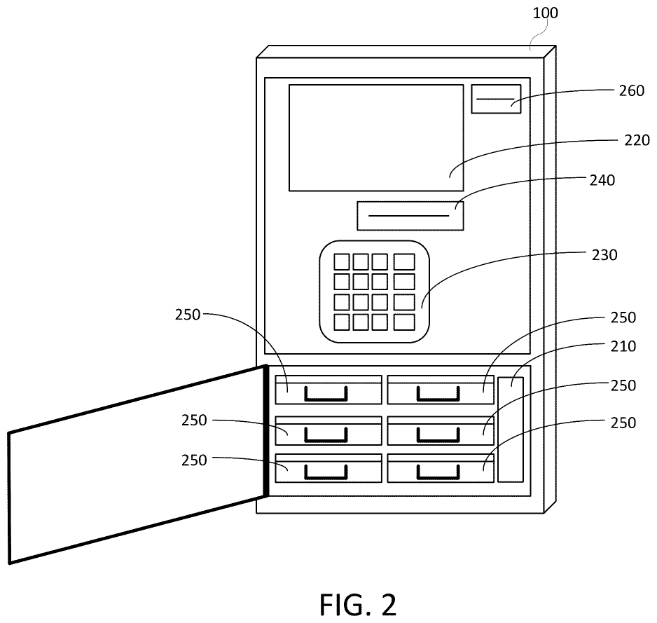

FIG. 2 illustrates example components of the automated teller machine 110. The automated teller machine 110 is adapted to provide access to banking services such as for example withdrawals and deposits. As shown in FIG. 2, the automated teller machine 110 includes a controller 210, a display 220, a keypad 230, an item receiver/dispenser 240, cassettes 250, and a card reader 260.

As further described below, the controller 210 is a computing device. For example, the controller 210 may include a processor that executes instructions retrieved from a computer-readable medium thereby causing the automated teller machine 110 to perform operations for providing access to banking services.

The display 220 may for example, be a liquid-crystal display (LCD), a cathode-ray tube (CRT), or the like. The display 220 may present a user interface to a customer or user of the automated teller machine 110.

The keypad 230 is an input device allowing input to be provided to the automated teller machine 110. Input received via the keypad 230 may be conveyed to the controller 210. The keypad 230 may be used by a user to provide a personal identification number (PIN) to the automated teller machine 110 as a part of authenticating to the automated teller machine 110.

The item receiver/dispenser 240 is a device allowing value instruments to be received by the automated teller machine 110 or dispensed by the automated teller machine 110. The value instruments may include banknotes and/or cheques. The item receiver/dispenser 240 may provide a single slot through which value instruments may be dispensed. Additionally or alternatively, the item receiver/dispenser 240 may provide multiple slots. It may be that components or units of the item receiver/dispenser 240 are specialized to a particular type or types of value instrument. For example, a particular component or unit of the item receiver/dispenser 240 may be adapted to receiving and/or dispensing banknotes of one denomination, while another component or unit may be adapted to receiving and/or dispensing banknotes of another denomination. Alternatively, it may be that the item receiver/dispenser 240 is a monolithic unit that handles all manner of value instruments.

As mentioned above, the automated teller machine includes one or more cassettes 250. The item receiver/dispenser 240 may be in communication with the cassettes 250. Some or all of the cassettes 250 may be adapted to dispense value instruments. For example, some of the cassettes 250 may be for dispensing banknotes of particular denominations.

The item receiver/dispenser 240 and the cassettes 250 may be collectively considered a value instrument dispenser adapted to dispense value instruments such as to satisfy withdrawals from the automated teller machine 110.

The card reader 260 allows data to be read from a card or access card such as for example a common ISO-sized automated teller machine or cheque card. For example, the card reader 260 may allow data to be read from magnetic stripe cards and/or chip cards. In some embodiments, the card reader 260 may require a card to be swiped through it to be read (a so-called “swipe reader”) and/or it may allow a card to be inserted into it for reading (a so-called “dip reader”). In some embodiments, the card reader 260 may be adapted to allow inserted cards to be retained by the automated teller machine 110 indefinitely (such as if fraud is suspected) and/or for the period of a session.

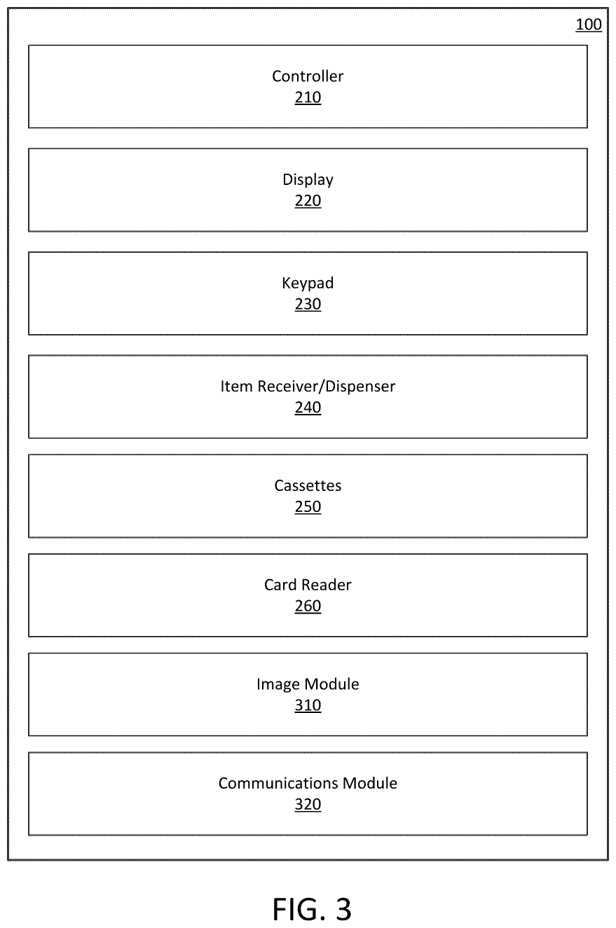

FIG. 3 is a logical block diagram of the automated teller machine 110. As described above, the automated teller machine 110 may include a controller 210, a display 220, a keypad 230, an item receiver/dispenser 240, cassettes 250, and a card reader 260 as described above. Additionally, as shown in FIG. 3, the automated teller machine 110 may include an image module 310 and a communications module 320.

The image module 310 is adapted to scan or capture images of value instruments received by the automated teller machine 110. For example, the image module 310 may scan or capture images of value instruments (such as, for example, bank notes, negotiable instruments like cheques, money orders, bank drafts, warrants of payment, etc.) as they are received by the automated teller machine 110 such as, for example, by way of the item receiver/dispenser 240. The image module 310 may include a colour, black and white, or a grayscale scanner. In one or more embodiments, image module 310 may include an ultraviolet scanner and the ultraviolet scanner may be engaged to identify security features for counterfeit detection. The image module 310 may include a number of scanning technologies. For example, the image module 310 may include a contact image sensor (CIS), a charge-coupled device (CCD), etc.

The communications module 320 allows the automated teller machine 110 to communicate with other computing devices and/or various communications networks such as, for example, the network 140. In other words, the communications module 320 may allow the automated teller machine 110 to send or receive communications signals. Communications signals may be sent or received according to one or more protocols or according to one or more standards. For example, the communications module 320 may allow the automated teller machine 110 to communicate via an Ethernet network, an automated teller machine network, a telephone network, and/or via cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 320 may allow the automated teller machine 110 to communicate using near-field communication (NFC), via Wi-Fi™, using Bluetooth™ or via some combination of one or more networks or protocols.

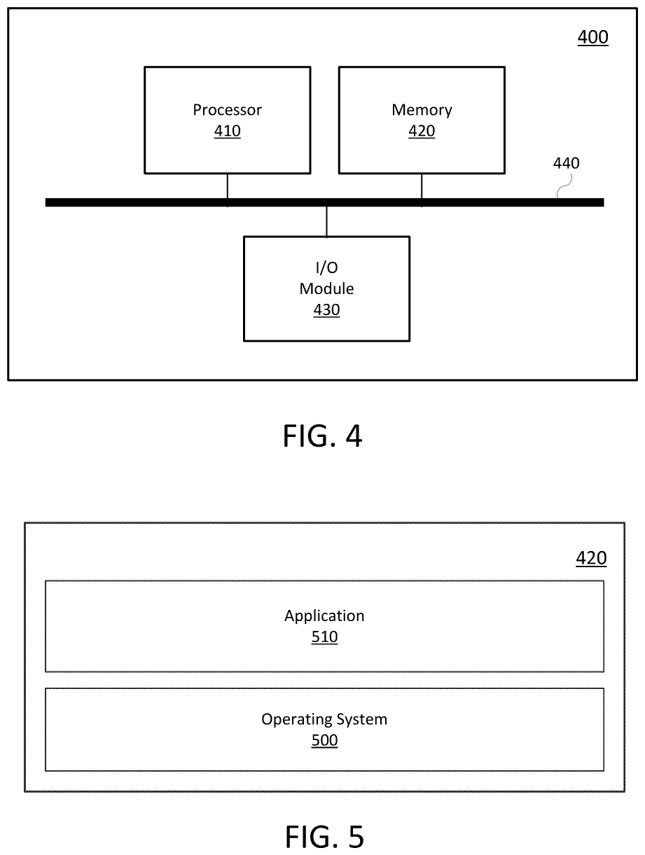

FIG. 4 is a high-level operation diagram of an example computing device 400. In some embodiments, the example computing device 400 may be exemplary of the controller 210 (FIG. 2), the automated teller machine switch 120, the server computer system 130, and/or the mobile device 150. Each of the automated teller machine 110, the automated teller machine switch 120, the server computer system 130 and the mobile device 150 include software that adapts it to perform a particular function.

The example computing device 400 includes a variety of modules. For example, as illustrated, the example computing device 400 may include a processor 410, a memory 420, and an input/output (I/O) module 430. As illustrated, the foregoing example modules of the example computing device 400 are in communication over a bus 440.

The processor 410 is a hardware processor. The processor 410 may, for example, be one or more ARM, Intel x86, PowerPC processors or the like.

The memory 420 allows data to be stored and retrieved. The memory 420 may include, for example, random access memory, read-only memory, and persistent storage. Persistent storage may be, for example, flash memory, a solid-state drive or the like. Read-only memory and persistent storage are non-transitory computer-readable storage mediums. A computer-readable medium may be organized using a file system such as may be administered by an operating system governing overall operation of the example computing device 400.

The I/O module 430 allows the example computing device 400 to interact with devices such as, for example, peripherals to send and receive data. The I/O module 430 may, for example, allow the example computing device 400 to interface with input devices such as, for example, keypads, keyboards, pointing devices, and the like. In another example, the I/O module 430 may, for example, allow the example computing device 400 to interface with output devices such as, for example, displays, printers, and the like. In a particular example, where the example computing device 400 forms a part of the automated teller machine 110 (FIG. 1) such as, for example, if the example computing device 400 is or forms a part of the controller 210 (FIG. 2) of the automated teller machine 110, the I/O module 430 may allow the example computing device 400 to interface with, for example, one or more of the display 220, the keypad 230, the item receiver/dispenser 240, cassettes 250, the card reader 260, the image module 310 and/or the communications module 320.

Software comprising instructions is executed by the processor 410 from a computer-readable medium. For example, software may be loaded into random-access memory from persistent storage of the memory 420. Additionally, or alternatively, instructions may be executed by the processor 410 directly from read-only memory of the memory 420.

FIG. 5 depicts a simplified organization of software components stored in the memory 420 of the example computing device 400 (FIG. 4). As illustrated, these software components include an operating system 500 and application 510.

The operating system 500 is software. The operating system 500 allows the application 510 to access the processor 410, the memory 420, and the I/O module 430 of the example computing device 400 (FIG. 4). The operating system 500 may be, for example, Google™ Android™, Apple™ iOS™, UNIX™, Linux™, Microsoft™ Windows™, Apple OSX™ or the like.

The application 510 adapts the example computing device 400, in combination with the operating system 500, to operate as a device performing a particular function. For example, the application 510 may cooperate with the operating system 500 to adapt a suitable embodiment of the example computing device 400 to operate as the controller 210 (FIG. 2) of the automated teller machine 110 (FIG. 1) and/or the server computer system 130.

While a single application 510 is illustrated in FIG. 5, in operation the memory 420 may include more than one application 510 and different applications 510 may perform different operations.

For example, in at least some embodiments in which the computing device 400 functions as the mobile device 150, the applications 510 may include a banking application. The banking application may be configured for secure communications with the server computer system 130 and may provide various banking functions such as, for example, the ability to display a quantum of value in one or more data records (e.g., display balances), configure or request that operations such as transfers of value (e.g., bill payments, email money transfers and other transfers) be performed, and other account management functions. The banking application may require in-app biometric authentication to be accessed.

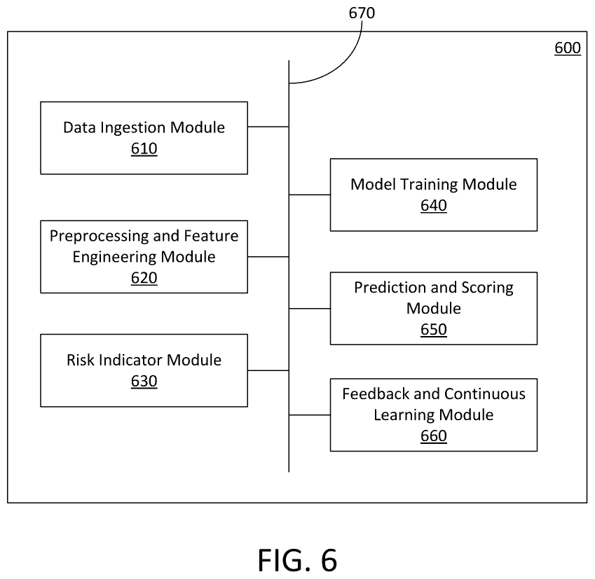

As mentioned, in one or more embodiments, the server computer system 130 may include an artificial intelligence engine trained to assess automated teller machine risk and/or automated teller machine session risk. FIG. 6 is an example schematic diagram outlining various components of an artificial intelligence engine 600. As can be seen, the artificial intelligence engine 600 includes a data ingestion module 610, a preprocessing and feature engineering module 620, a risk indicator module 630, a model training module 640, a prediction and scoring module 650, and a feedback and continuous learning module 660. The various components communicate with one another over a pipeline 670.

The data ingestion module 610 collects and integrates raw data from various sources. For automated teller machine risk, the data ingestion module 610 may aggregate data such as for example location-based crime statistics, historical fraud reports, automated teller machine operational logs, long-term usage patterns, etc. For automated teller machine session risk, the data ingestion module 610 may ingest real-time automated teller machine session data. The real-time automated teller machine session data may include, for example, transaction timestamps, card information, withdrawal amounts, failed login attempts, etc. The data may be normalized and stored in appropriate formats within a database.

The preprocessing and feature engineering module 620 performs data cleaning, transformation, and feature extraction. For automated teller machine risk, preprocessing may include the imputation of missing values in historical fraud data, normalization of crime statistics, encoding categorical data such as automated teller machine type (e.g. bank branch vs. standalone). Feature engineering may derive metrics such as for example area risk score, historical fraud score, etc. For automated teller machine session risk, preprocessing may include encoding real-time transactional details (e.g. transaction amount, time of day) and calculating dynamic features such as transaction frequency (number of transactions within a short window), time risk factor (based on high-risk operational hours), card usage anomaly (inconsistency with past usage patterns). The preprocessing and feature engineering module 620 may output standardized feature vectors for both automated teller machine risk and automated teller machine session risk.

The risk indicator module 630 may consolidate processed features into intermediate risk metrics. For automated teller machine risk, the risk indicator module 630 may compute metrics such as fraud history score (derived by weighting recent fraud incidents more heavily than older ones), proximity risk (based on the density of nearby high-risk automated teller machines), and/or operational risk score. For automated teller machine session risk, the risk indicator module 630 may calculate real-time indicators such as transaction suspicion score (based on thresholds for withdrawal amounts or failed attempts), geographic anomaly (flagging transaction occurring far from usual cardholder locations), and/or temporal risk (assessing time of day risk using clustering or historical fraud patterns).

The model training module 640 may train machine learning models to assess automated teller machine risk and automated teller machine session risk. For automated teller machine risk, supervised machine learning algorithms such as Random Forest may be trained on labeled data where automated teller machines are classified as high-risk or low-risk based on past fraud reports and environmental factors. The training may include splitting data into training, validation, and test sets. For automated teller machine session risk, supervised machine learning algorithms such as Random Forest may be trained using dynamic data. For example, the model may be trained on labeled automated teller machine session data (e.g. fraudulent vs. legitimate). As will be appreciated, hyperparameters may be optimized to enhance predictive accuracy.

The prediction and scoring module 650 applies the trained machine learning model to new or unseen data to classify automated teller machines or automated teller machine sessions as high-risk or low-risk. For example, for automated teller machines, the prediction and scoring module 650 may process updated aggregate data through the trained automated teller machine risk model. The model may assign a numerical risk score or binary classification or flag for a particular automated teller machine. For example, input data may be preprocessed using the transformations and feature engineering steps applied during training to ensure consistency. The feature vector may then be fed into the trained machine learning model to output a numerical risk score (e.g. 0 to 1, indicating the likelihood of fraud) or a binary flag (1 for high risk, 0 for low risk) based on a decision threshold. This process may be executed periodically to provide updated risk profiles for all automated teller machines within a network and the result may be stored in a database or may be sent to the automated teller machine for storage locally thereon. As another example, for automated teller machine sessions, the prediction and scoring module 650 may process automated teller machine session data such as transactional data in real time. The incoming automated teller machine session data may be transformed into feature vectors using the same preprocessing steps as during training. The trained automated teller machine session model may output a score or classification indicating whether the automated teller machine session is suspicious. The prediction and scoring module 650 may be deployed as an API endpoint to enable real-time risk scoring. The outputs may be logged in a monitoring system to track predictions over time and to identify any drift in model behavior.

The feedback and continuous learning module 660 may incorporate feedback from flagged automated teller machines and/or flagged automated teller machine sessions and may update the model over time. For example, confirmed fraud incidents, false positives and/or false negatives may be logged and used to update the training dataset. Periodic retraining may be performed using, for example, incremental learning algorithms and/or full retraining may be performed using an expanded dataset. Drift detection may be employed to ensure the model remains relevant as fraud patterns evolve.

The artificial intelligence engine 600 may be engaged to determine whether or not an automated teller machine and/or an automated teller machine session is high risk. For example, an automated teller machine may be classified as high risk based on the location of the automated teller machine being in a crime-prone area, based on the automated teller machine having a history of fraudulent transactions, etc. The classification of an automated teller machine being high risk may reflect the automated teller machine's overall environment and operational history. As another example, an automated teller machine session may be classified as high risk based on transaction specific and real-time features such as unusual withdrawal patterns, transaction timing, or anomalies in user behavior such as for example card usage far from the customer's normal location.

It will be appreciated that an automated teller machine session initiated at an automated teller machine classified as high risk may not necessarily be classified as high risk if the transaction patterns and user behavior appear normal and don't match fraud signals. That being said, automated teller machines classified as high risk may have a higher probability of hosting high risk automated teller machine sessions due to their environment. Similarly, an automated teller machine session may be classified as high risk by the artificial intelligence engine 600 even when it is initiated at an automated teller machine that is classified as low risk. The artificial intelligence engine 600 is trained in manners described herein to evaluate automated teller machine factors and automated teller machine session factors independently to avoid bias or overgeneralization.

In one or more embodiments, the server computer system 130 may engage the artificial intelligence engine 600 to periodically classify an automated teller machine as high risk or low risk. For example, the server computer system 130 may maintain a database that includes a list of all automated teller machines associated therewith, where each automated teller machine may be identified by an automated teller machine identifier. The list may include information such as for example geographic location of each automated teller machine and this may include an address. The list may include additional information such as data identifying whether the automated teller machine is located in-branch or out-of-branch. The list may also include a risk score associated with the automated teller machine. In one or more embodiments, the risk score may be represented by a binary flag, where the flag is set to 0 when the automated teller machine is considered low risk and set to 1 when the automated teller machine is considered high risk. In these embodiments, a simple binary flag is maintained and periodically updated. The use of a binary flag allows the server computer system 130 to track the risk score for all associated automated teller machines while minimizing memory usage and computer resources. This results in lower memory consumption and reduced network bandwidth when communicating the risk score to requesting parties.

In one or more embodiments, the classification of an automated teller machine may be performed using automated teller machine session data from multiple days such as for example from a current day to the past nine (9) days. The automated teller machine session data may be weighted using a decaying weight system such as for example today 1.0, yesterday 0.9, the day before 0.8, etc. It will be appreciated that a more complex decay such as for example exponential decay may be used where each prior day has an exponentially smaller influence on the risk score. Further, the automated session data may be obtained using a fixed look-back window (e.g. the last seven (7) days) which may allow the artificial intelligence engine to account for recent trends while still smoothing out random fluctuations over a short time period. By using automated teller machine session data from multiple days, the artificial intelligence engine may smooth out short-term fluctuation and focus more on overall trends leading to more stable and reliable risk scores. Further, the artificial intelligence engine may identify patterns over a longer period of time. Further, weighting the automated teller machine session data may mitigate the effect of one-off events that may skew the risk score if only a single day's automated teller machine session data is considered.

In one or more embodiments, rather than classifying the automated teller machine based on automated teller machine session data from multiple days, the automated teller machine may be classified by weighting classification scores from the multiple days. For example, the risk scores may be weighted using a decaying weight system such as for example today 1.0, yesterday 0.9, the day before 0.8, etc. In this example, the risk scores from these days may be combined with the weighted factors to generate a final risk score. This approach may balance short-term volatility with long-term risk patterns and this may increase stability while still responding to recent trends.

In one or more embodiments, the risk score may be communicated to the associated automated teller machine and stored in its memory. This may allow the automated teller machine to include its risk score as part of automated teller machine session data during automated teller machine sessions.

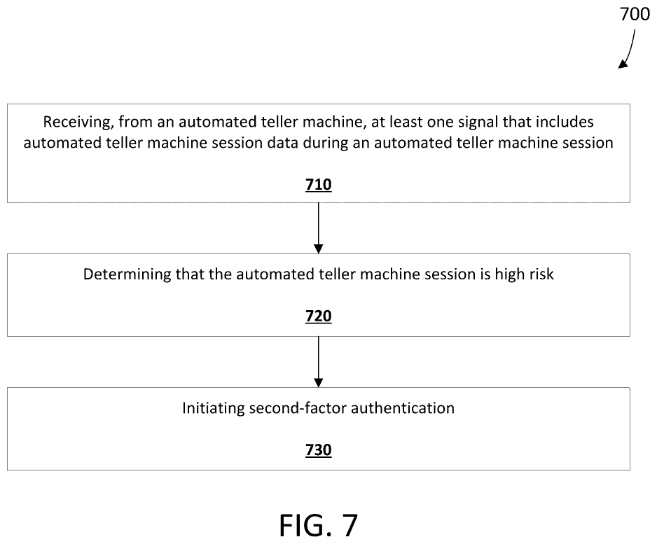

The server computer system 130 may initiate second factor authentication in response to determining that an automated teller machine session is high risk. Reference is made to FIG. 7, which illustrates, in flowchart form, a method 700 for initiating second factor authentication. The method 700 may be implemented by a computing device having suitable processor-executable instructions for causing the computing device to carry out the described operations. The method 700 may be implemented, in whole or in part, by the server computer system 130. At least some of the operations may be offloaded to the automated teller machine 110.

The method 700 includes receiving, from an automated teller machine, at least one signal that includes automated teller machine session data during an automated teller machine session (step 710).

The automated teller machine session may be initiated when an authentication token such as for example a card having a chip is inserted into the card reader 260. The automated teller machine 110 may require a user to authenticate the authentication token. For example, in one or more embodiments, the automated teller machine 110 may prompt the user to enter a PIN associated with the card that was inserted into the card reader 260. The user may enter the PIN using, for example, the keypad 230 of the automated teller machine 110.

Responsive to receiving the PIN, the automated teller machine 110 may encrypt the entered PIN using a secure encryption protocol before transmitting it along with the card data to the server computer system 130. The server computer system 130 validates the PIN against data stored in a database. If the PIN is confirmed to match the card's associated account, the server computer system 130 sends at least one signal notifying the automated teller machine 110 that the authentication was successful. Once authenticated, the server computer system 130 may identify the account associated with the authentication token and may relay this information to the automated teller machine 110 to proceed with the automated teller machine session. It will be appreciated that authentication using the authentication token and PIN (chip and PIN) may be performed as a first factor authentication.

During the automated teller machine session, the automated teller machine 110 communicates signals that include automated teller machine session data to the server computer system 130. In one or more embodiments, the automated teller machine session data may be transmitted or sent in discrete messages based on specific events or triggers during the automated teller machine session. For example, when a user authenticates using chip and PIN, at least one signal is sent by the automated teller machine 110 to the server computer system 130 to validate credentials. As another example, when a user requests a withdrawal, at least one signal is sent by the automated teller machine 110 to the server computer system 130 to verify account balance and authorize the transaction. As yet another example, when the automated teller machine session ends, at least one signal is sent by the automated teller machine 110 that includes a summary or log of the automated teller machine session.

The automated teller machine session data may include different types of data based on different triggers. For example, upon card insertion and PIN entry, the automated teller machine 110 may send automated teller machine session data that includes card information (PAN, expiration date), encrypted PIN data, and automated teller machine data such as for example an automated teller machine identifier of the automated teller machine 110.

As another example, when a user selects a transaction option, the automated teller machine 110 may send automated teller machine session data that includes the transaction type, the requested amount, account type, the automated teller machine identifier of the automated teller machine 110, and a session identifier for the automated teller machine session.

As yet another example, the automated teller machine 110 may send automated teller machine session data that includes session status updates, error reports, operational issues, etc. This data may be sent continuously or at specific checkpoints during the automated teller machine session. For example, a session timeout signal may be sent if the automated teller machine session is inactive for too long.

As still yet another example, upon completion of a requested action, the automated teller machine 110 may send automated teller machine session data that includes transaction results (success or failure), updated balance data, confirmation code data, etc.

The method 700 includes determining, based on the automated teller machine session data, that the automated teller machine session is high risk (step 720).

In one or more embodiments, determining that the automated teller machine session is high risk may include analyzing the automated teller machine session data to determine whether or not the automated teller machine session is high risk.

In one or more embodiments, the automated teller machine session may be determined as high risk at least when it is determined that the automated teller machine is located in an area known to be high risk. In these embodiments, the automated teller machine session may be analyzed to determine that the automated teller machine is located in an area known to be high risk. For example, the automated teller machine session data may include an automated teller machine identifier. The server computer system 130 may use the automated teller machine identifier to identify a location of the automated teller machine and this may be done, for example, by consulting a database that associates automated teller machine identifiers to locations of automated teller machines. The server computer system 130 may analyze the location of the automated teller machine to determine that the automated teller machine is in a location known to be high risk based on, for example, crime statistic data that may be retrieved from one or more third parties.

As mentioned, the server computer system 130 may maintain a risk score for the automated teller machine 110 that may be stored in a database and/or may be stored in memory of the automated teller machine 110. As such, in one or more embodiments, the automated teller machine session may be determined as high risk at least when it is determined that the automated teller machine is high risk. For example, the automated teller machine session data may include a binary flag that is set to 1 when the automated teller machine is high risk and set to zero 0 when the automated teller machine is low risk. As such, the server computer system 130 may analyze the automated teller machine session data to identify the risk score and may determine that the automated teller machine session is high risk when the risk score indicates that the automated teller machine is high risk.

In one or more embodiments, the automated teller machine session may be determined as high risk at least when it is determined that the automated teller machine session is being performed at a time known to be high risk. For example, the server computer system 130 may determine a time of the automated teller machine session either locally or by analyzing the automated teller machine session data and may determine that the time is within a period of time known to be high risk. The period of time may include a period of time when a branch hosting the automated teller machine is closed. Other examples may include a period of time outside of business hours, etc. In one or more embodiments, the period of time may be based on crime statistic data that indicates times when crimes are more likely to occur such as for example between the hours of 11:00 PM and 5:00 AM.

In one or more embodiments, the automated teller machine session may be determined as high risk at least based on one or more transactions requested during the automated teller machine session. In these embodiments, the server computer system 130 may analyze the automated teller machine session data to identify a withdrawal amount requested during the automated teller machine session. The server computer system 130 may determine, based on the withdrawal amount, that the automated teller machine session is high risk and this may be based on comparing the withdrawal amount to a threshold amount such as for example five hundred dollars ($500). In one or more embodiments, the threshold amount may be dependent on the account being accessed where different accounts may be associated with different threshold amounts based on past transaction history, account balance, etc.

In one or more embodiments, to determine that the automated teller machine session is high risk, the server computer system 130 may engage an artificial intelligence engine to analyze the automated teller machine session data. The artificial intelligence engine may include the artificial intelligence engine 600 described herein. For example, the automated teller machine session data may be provided as input and the artificial intelligence engine 600 may analyze the automated teller machine session data to generate a risk score or classify the automated teller machine session as high risk or low risk.

As described herein, the artificial intelligence engine 600 may classify the automated teller machine session as high risk based on transaction specific and real-time features such as unusual withdrawal patterns, transaction timing, or anomalies in user behavior (e.g. card usage far from the customer's normal location). This classification is determined at least partially based on the automated teller machine session data.

Additionally, through use of the artificial intelligence engine 600, an automated teller machine session initiated at an automated teller machine classified as high risk may not necessarily be classified as high risk if transaction patterns and user behavior appear normal and don't match typical fraud signals. However, automated teller machines classified as high risk may have a higher likelihood of hosting high risk automated teller machine sessions due to their environment. Conversely, an automated teller machine session may be classified as high risk by the artificial intelligence engine 600 even if it is initiated at an automated teller machine classified as low risk.

Responsive to determining that the automated teller machine session is high risk, initiating second factor authentication (step 730).

Responsive to determining that the automated teller machine session is high risk, the server computer system 130 may initiate second factor authentication. The server computer system 130 may initiate the second factor authentication automatically and in response to determining that the automated teller machine session is high risk. For example, at least one function may be requested during the automated teller machine session that may deem the automated teller machine session high risk and as such second factor authentication may be required to authorize the at least one function. In this example, the at least one function may include initiating the automated teller machine session or authorizing a transaction requested during the automated teller machine session.

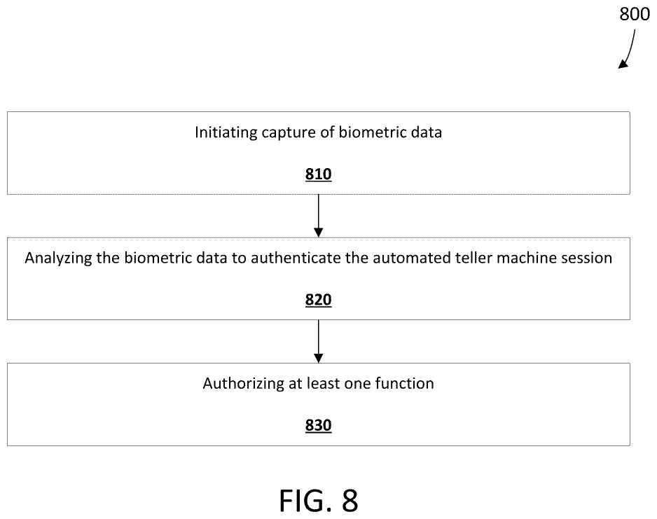

In one or more embodiments, the second factor authentication may include biometric data verification such as for example identity verification through image-based biometrics. Reference is made to FIG. 8, which illustrates, in flowchart form, a method 800 for biometric data verification. The method 800 may be implemented by a computing device having suitable processor-executable instructions for causing the computing device to carry out the described operations. The method 800 may be implemented, in whole or in part, by the server computer system 130. At least some of the operations may be offloaded to the automated teller machine 110.

The method 800 includes initiating capture of biometric data (step 810).

As mentioned, responsive to determining that the automated teller machine session is high risk, the server computer system 130 may initiate second factor authentication. In one or more embodiments, the second factor authentication may include identity verification through image-based biometrics. The server computer system 130 may initiate the second factor authentication automatically and in response to determining that the automated teller machine session is high risk.

In one or more embodiments, the biometric data may include image data. In these embodiments, initiating the second factor authentication may include initiating image capture to obtain image data. To initiate image capture, at least one signal may be sent to an imaging device to initiate the image capture.

The imaging device may include an imaging device associated with the automated teller machine 110. For example, the automated teller machine 110 may include an imaging device that may be positioned to capture image data of an operator of the automated teller machine 110. The imaging device may include a built-in camera that is integrated directly into the automated teller machine 110.

The imaging device may include an imaging device that is positioned in proximity to the automated teller machine 110. For example, the automated teller machine 110 may be located at a branch and as such the imaging device may include an imaging device installed within the branch and positioned to capture image data of an operator of the automated teller machine 110. The imaging device may include a ceiling-mounted camera, a wall-mounted camera, a corner-mounted camera.

The imaging device may additionally or alternatively include a standalone camera that may be installed at a covert location without being easily noticeable.

The imaging device may receive the signal to initiate the image capture and in response the imaging device may capture the image data. The image data may include a still image, a video, and/or a sequence of frames. The imaging device may process the captured image data if required using compression, encryption, etc. as required. The imaging device sends the image data to the server computer system 130 for processing. In this manner, the server computer system 130 initiates image capture to obtain the image data.

The method 800 includes analyzing the biometric data to authenticate the automated teller machine session (step 820).

The server computer system 130 analyzes the biometric data to authenticate the automated teller machine session and this may be done through image-based biometrics. For example, in one or more embodiments, analyzing the biometric data may include preprocessing image data to detect a face in the image data, to align the image data, to normalize the image data, etc. In one or more embodiments, analyzing the image data may include processing the image data to generate feature vectors. For example, in one or more embodiments, facial recognition models may be utilized to generate facial embeddings which may include a numerical representation of the person's face. These embeddings may include feature vectors of a fixed-size that summarize the unique features of the face.

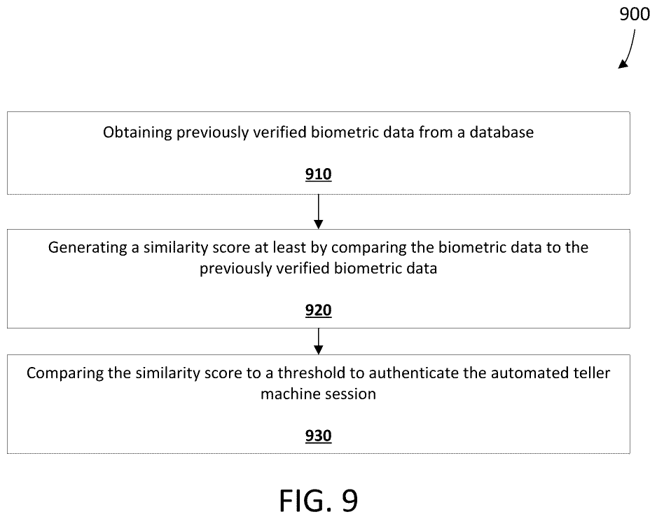

In one or more embodiments, the server computer system 130 verifies the identity using image comparison. Reference is made to FIG. 9, which illustrates, in flowchart form, a method 900 for verifying identity using image comparison. The method 900 may be implemented by a computing device having suitable processor-executable instructions for causing the computing device to carry out the described operations. The method 900 may be implemented, in whole or in part, by the server computer system 130.

The method 900 includes obtaining previously verified biometric data from a database (step 910).

In one or more embodiments, the server computer system 130 may obtain the previously verified biometric data based on the account identified during the first factor authentication such as for example based on the authentication token and/or PIN entered during the initiation of the automated teller machine session. Specifically, the server computer system 130 may perform a lookup of the account and may retrieve the previously verified biometric data that was stored in association with the account.

The previously verified biometric data may include previously verified image data. For example, in one or more embodiments, the previously verified image data may include image data from an image previously captured of the customer and verified as authentic. For example, the image data may be from a government issued identification such as a driver's license, passport, etc.

In one or more embodiments, the previously verified biometric data may be stored in a format such that no additional processing is required on the previously verified biometric data during the comparison. For example, rather than saving an entire previously verified image, only meaningful features may be extracted from the previously verified image and saved as the previously verified image data. This reduces memory usage while retaining only the previously verified image data necessary for authentication.

In one or more embodiments, facial recognition models may be utilized to generate facial embeddings which may include a numerical representation of the person's face. These embeddings may include feature vectors of a fixed-size that summarize the unique features of the face. The memory required to store the previously verified image data is reduced as feature vectors are much smaller than raw image files. Further, the processing required for comparison is reduced as the feature vectors may be compared to new image data feature vectors using similarity metrics.

The method 900 includes generating a similarity score at least by comparing the biometric data to the previously verified biometric data (step 920).

In embodiments where the biometric data includes image data, to generate the similarity score, features are extracted from the image data using the same preprocessing and feature extraction techniques that were used to generate the previously verified image data.

The similarity score is generated using metrics such as for example cosine similarity to compare the stored feature vector of the previously verified image data to the feature vector of the new image data. For example, cosine similarity may provide a numerical value between −1 and 1 where 1 indicates the vectors are identical in direction, 0 means the vectors are orthogonal (completely dissimilar), and −1 means the vectors are diametrically opposed. It will be appreciated that the range of cosine similarity may be restricted to [0, 1] for image embeddings in facial recognition as the embeddings may be normalized to non-negative values.

The method 900 includes comparing the similarity score to a threshold to authenticate the automated teller machine session (step 930).

In one or more embodiments, the threshold may be set to a value of 0.8 and this may be based on expected range of similarity scores for different images of the same person. Put another way, since the embeddings of images from the same person should be very similar, the expected range of similarity scores is between 0.8 and 1.0 and this may depend on the quality of images, the preprocessing steps, and the model used for feature extraction. As such, a similarity score greater than or equal to the threshold may indicate that the image data and the previously verified image data are a match and the identity is verified.

As will be appreciated, a similarity score less than the threshold may indicate that the image data and the previously verified image data are not a match and as a result the identity is not verified.

Once the identified has been verified, the automated teller machine session may be authenticated.

The method 800 includes responsive to authenticating the automated teller machine session, authorize at least one function during the automated teller machine session (step 830).

Responsive to authenticating the automated teller machine session, the server computer system 130 authorizes at least one function. For example, as mentioned, the at least one function may include initiating the automated teller machine session and as such the server computer system 130 may send at least one signal to the automated teller machine 110 indicating that the automated teller machine session is initiated. As another example, the at least one function may include authorizing a transaction requested during the automated teller machine session and as such the server computer system 130 and/or the automated teller machine 110 may perform operations to complete the requested transaction (withdrawal, transfer, etc.). As one example, the automated teller machine 110 may dispense money as requested during the automated teller machine session in response to successful identity verification.

In manners described herein, identity verification using biometric data such as for example through image-based biometrics may be performed as a second factor authentication during the automated teller machine session only when the automated teller machine session is determined to be high risk. Further, in one or more embodiments, by only storing feature vectors of the previously verified image data, the memory required for identity verification through image-based biometrics is reduced and the processing required for image data comparison is reduced.

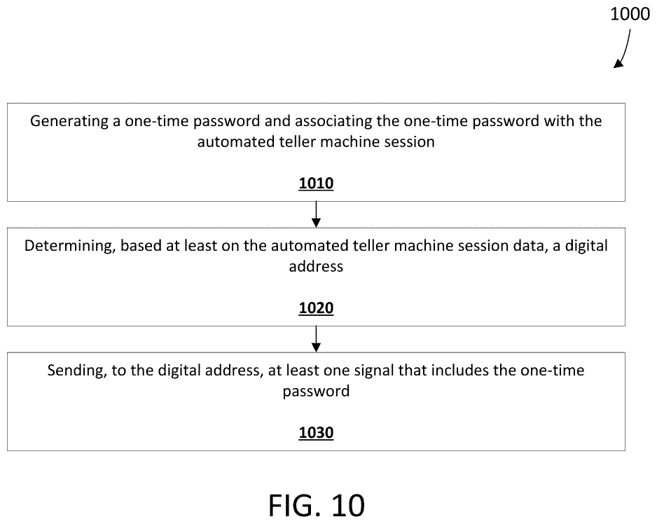

As mentioned, in response to determining that the automated teller machine session is high risk, the server computer system 130 may initiate second factor authentication. In one or more embodiments, the second factor authentication may include identity verification using one-time password authentication. In these embodiments, the server computer system 130 may send a one-time password that may be required for identity verification. Reference is made to FIG. 10, which illustrates, in flowchart form, a method 1000 for sending a one-time password. The method 1000 may be implemented by a computing device having suitable processor-executable instructions for causing the computing device to carry out the described operations. The method 1000 may be implemented, in whole or in part, by the server computer system 130. At least some of the operations may be offloaded to the automated teller machine 110.

The method 1000 includes generating a one-time password and associating the one-time password with the automated teller machine session (step 1010).

As mentioned, responsive to determining that the automated teller machine session is high risk, the server computer system 130 may initiate second factor authentication which in this embodiments includes identity verification using one-time password authentication. The server computer system 130 may initiate the second factor authentication automatically and in response to determining that the automated teller machine session is high risk.

In one or more embodiments, the server computer system 130 may generate the one-time password by engaging a secure random number generator. In one or more embodiments, the one-time password may include a four (4) digit random number. It will be appreciated that the one-time password may alternatively include more or less digits.

In one or more embodiments, an expiration time may be defined for the one-time password. For example, the one-time password may expire after one (1) minute, two (2) minutes, five (5) minutes etc.

The one-time password is associated with the automated teller machine session. For example, the automated teller machine session may be assigned an automated teller machine session identifier and as such the one-time password may be associated with the automated teller machine session identifier. It will be appreciated that the one-time password and/or automated teller machine session identifier may also be associated with the account being accessed during the automated teller machine session as determined based on the automated teller machine session data in manners described herein.

In one or more embodiments, the one-time password may be stored in a database with a timestamp, expiration time, and in association with the automated teller machine session identifier.

The method 1000 includes determining, based at least on the automated teller machine session data, a digital address (step 1020).

In one or more embodiments, the server computer system 130 may obtain the digital address based on the account identified during the first factor authentication such as for example based on the authentication token and/or PIN entered during the initiation of the automated teller machine session. Specifically, the server computer system 130 may perform a lookup of the account and may retrieve a digital address that was stored in association with the account. The digital address may include at least one of a telephone number, an electronic mail address, or a device token that uniquely identifies a recipient device or user account, based on an installed mobile app, for delivering communications such as notifications, messages, or authentication codes via the respective communication channel. The installed mobile app may be associated with the server computer system 130 and may be resident on a computing device such as the mobile device 150.

The method 1000 includes sending, to the digital address, at least one signal that includes the one-time password (step 1030).

The server computer system 130 sends at least one signal that includes the one-time password. In one or more embodiments, the one-time password may be sent to the digital address via short message service (SMS), electronic mail, or push notification. For example, if the digital address includes a telephone number, the server computer system 130 may send the one-time password via SMS. To send the one-time password via SMS, the server computer system 130 may integrate with an SMS gateway to send the one-time password to the telephone number.

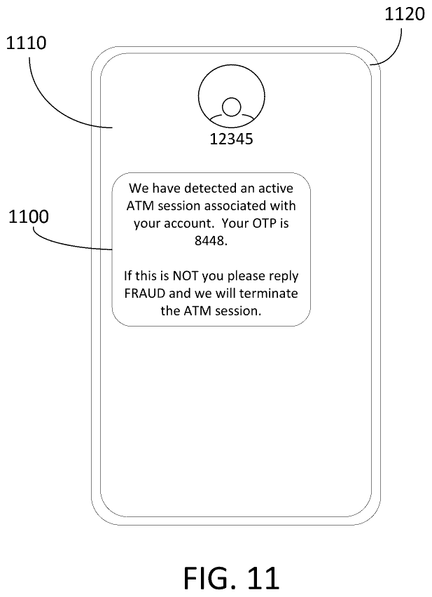

An example SMS message 1100 displayed on a display screen 1110 of a computing device 1120 is shown in FIG. 11. The computing device 1120 may be the mobile device 150 described herein. As can be seen, the SMS message 1100 includes a one-time password 8448. The SMS message also prompts the user that an active automated teller machine session has been initiated and requests that the user reply with FRAUD if the active automated teller machine session has not been initiated by them.

As another example, if the digital address includes an electronic mail address, the server computer system 130 may send the one-time password via email. To send the one-time password via email, the server computer system 130 may utilize a simple mail transfer protocol (SMTP) service or an email application programming interface (API) to send the one-time password to the electronic mail address.

As yet another example, if the digital address includes a device token, the server computer system 130 may send the one-time password via a push notification. It will be appreciated that the push notification may either be displayed within the installed mobile application or within the notification center on the computing device, depending on user-defined preferences. To send the one-time password via push notification the server computer system 130 may utilize a push notification API.

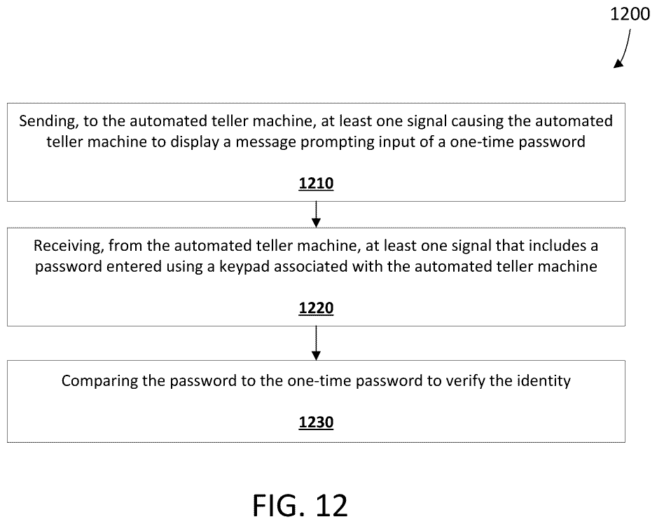

The one-time password may be used by the server computer system 130 for identity verification. Reference is made to FIG. 12, which illustrates, in flowchart form, a method 1200 for identity verification using one-time password authentication. The method 1200 may be implemented by a computing device having suitable processor-executable instructions for causing the computing device to carry out the described operations. The method 1200 may be implemented, in whole or in part, by the server computer system 130. At least some of the operations may be offloaded to the automated teller machine 110.

The method 1200 includes sending, to the automated teller machine, at least one signal causing the automated teller machine to display a message prompting input of a one-time password (step 1210).

The server computer system 130 may send the at least one signal causing the automated teller machine to display the message prompting input of a one-time password after the one-time password has been generated such as for example during the step 1010 of method 1000. In one or more embodiments, the at least one signal causing the automated teller machine to display the message prompting input of a one-time password may be sent simultaneously with the at least one signal sent to the digital address during the step 1030 of the method 1000.

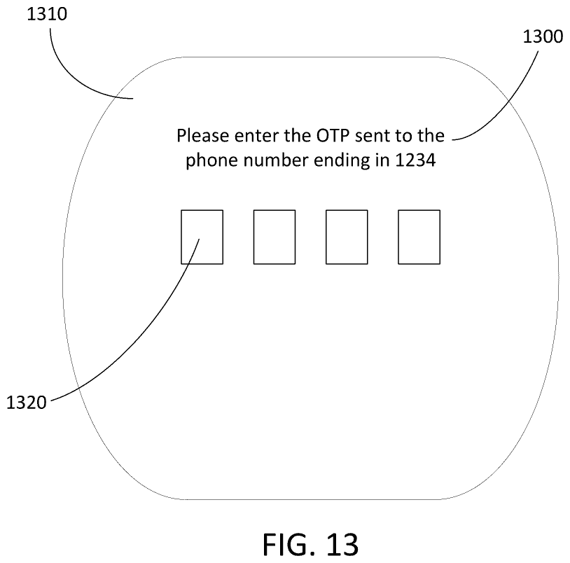

The at least one signal causes the automated teller machine 110 to display a message prompting input of the one-time password. An example message 1300 displayed on a display screen 1310 of an automated teller machine is shown in FIG. 13. As can be seen, the message includes a prompt requesting input of the one-time password. In this example, the message also includes a portion of the digital address that received the one-time password. The message also includes input fields 1320 that are populated as the one-time password is entered. It will be appreciated that the number of input fields 1320 displayed match the number of digits in the one-time password.

The method 1200 includes receiving, from the automated teller machine, at least one signal that includes a password entered using a keypad associated with the automated teller machine (step 1220).

A password may be entered using the keypad associated with the automated teller machine 110. The automated teller machine 110 may send the at least one signal in response to determining that all digits of the password have been entered or in response to selection of an interface element for submitting the password.

The server computer system 130 receives at least one signal that includes the password entered using the keypad associated with the automated teller machine 110.

The method 1200 includes comparing the password to the one-time password to verify the identity (step 1230).

The server computer system 130 compares the password received from the automated teller machine 110 to the one-time password associated with the automated teller machine session. The server computer system 130 verifies the identity when it is determined that the password received from the automated teller machine 110 matches the one-time password associated with the automated teller machine session.

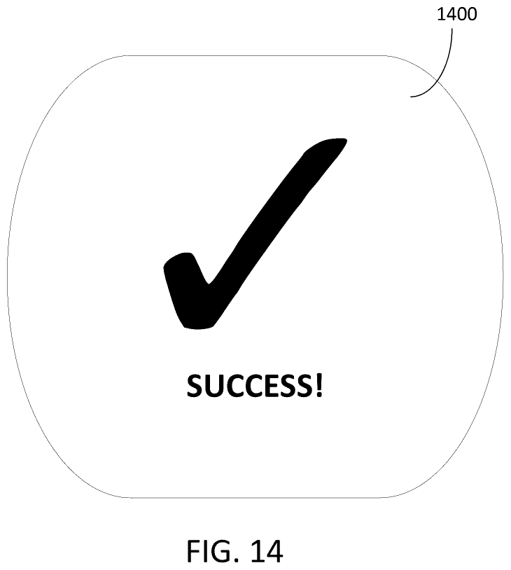

In response to determining that the password received from the automated teller machine 110 matches the one-time password associated with the automated teller machine session, the automated teller machine 110 may send at least one signal causing the automated teller machine to display an indication that the identity verification is successful. An example indication 1400 is shown in FIG. 14. As can be seen, the indication 1400 includes a checkmark and a message “Success!”.

Responsive to verifying the identity using one-time password authentication, the server computer system 130 authorizes at least one function. For example, as mentioned, the at least one function may include initiating the automated teller machine session and as such the server computer system 130 may send at least one signal to the automated teller machine 110 indicating that the automated teller machine session is initiated. As another example, the at least one function may include authorizing a transaction requested during the automated teller machine session and as such the server computer system 130 and/or the automated teller machine 110 may perform operations to complete the requested transaction (withdrawal, transfer, etc.). As one example, the automated teller machine 110 may dispense money as requested during the automated teller machine session in response to successful identity verification.

As mentioned, an expiration time may be defined for the one-time password. In one or more embodiments, the server computer system 130 may determine that the expiration time has passed and may perform one or more operations. For example, the server computer system 130 may determine that no response has been received from the automated teller machine 110 for an amount of time equal to the expiration time. In this example, the time may be based on how long the automated teller machine 110 has displayed the message prompting input of the one-time password.

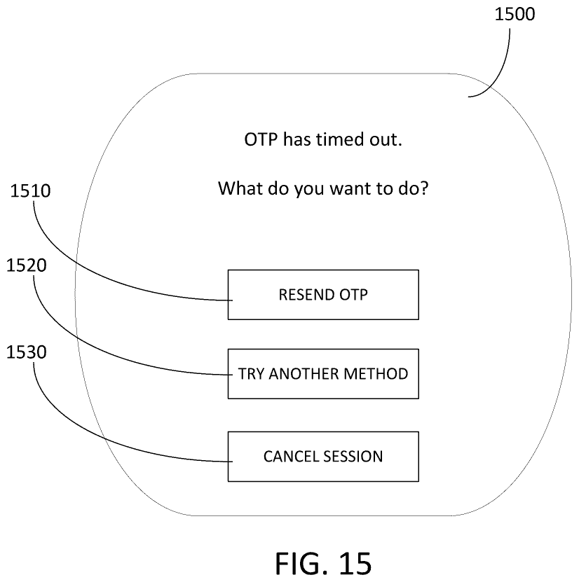

In one or more embodiments, when it is determined that the expiration time has passed, the server computer system 130 may send at least one signal causing the automated teller machine 110 to display a message indicating that the one-time password has timed out and prompting that the user select one or more next operations. An example is shown in FIG. 15. As can be seen, a message 1500 is displayed that indicates that the one-time password has expired. The user is prompted to select a next operation and this may be done by selecting a selectable option 1510 for resending a new one-time password, a selectable option 1520 for trying another second factor authentication method, or a selectable option 1530 for cancelling the automated teller machine session.

Selection of the selectable option 1510 may cause the server computer system 130 to re-generate a one-time password in manners similar to the described herein.

Selection of the selectable option 1520 may cause the server computer system 130 to perform one or more other second factor authentication methods such as for example verifying identity through image-based biometrics and/or in-app biometric authentication.

Selection of the selectable option 1520 may terminate the automated teller machine session.

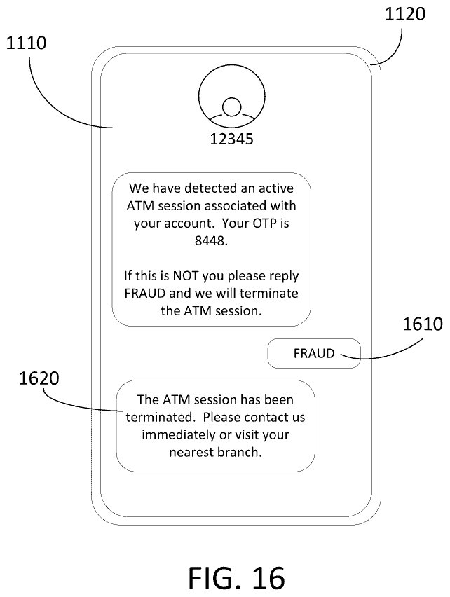

As mentioned, when sending the at least one signal that includes the one-time password to the digital address, the user may be informed that an active automated teller machine session has been initiated and the user may have the option to reply with ‘FRAUD’ if the active automated teller machine session has not been initiated by them. An example reply message is shown in FIG. 16. As can be seen, the user has replied to the SMS message 1100 (FIG. 11) with a message 1610 that includes the word ‘FRAUD’ indicating that the active automated teller machine session was not initiated by them. In response, the server computer system 130 may reply with a message 1620 that includes an indication that the automated teller machine session has been terminated and a recommendation to contact the financial institution immediately.

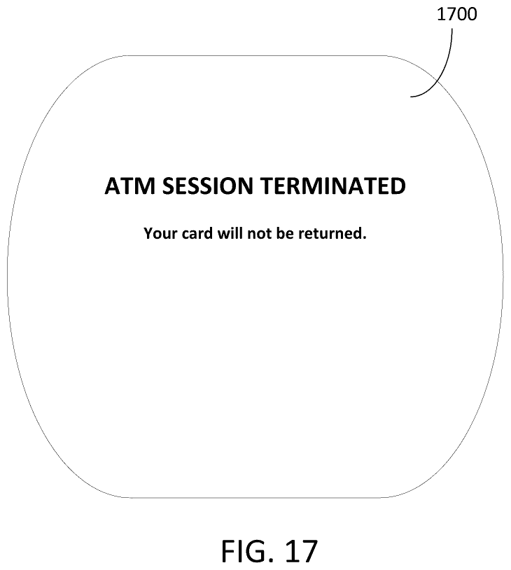

In response to receiving a reply containing the word ‘FRAUD’, the server computer system 130 may send a signal to the automated teller machine 110 to cancel or terminate the automated teller machine session. The automated teller machine 110 may then terminate the automated teller machine session and display a message indicating that the session has been terminated. In one or more embodiments, the automated teller machine 110 may retain the card used to initiate the automated teller machine session instead of returning it and this may be done to prevent further fraudulent attempts using the card. An example message 1700 indicating that the session has been terminated and that the card will not be returned is shown in FIG. 17.

It will be appreciated that, in response to receiving the reply containing the word ‘FRAUD’, the server computer system 130 may freeze the associated account(s) until the customer has contacted the financial institution to confirm fraud and to receive a new card.

In one or more embodiments described herein, identity verification using a one-time password may only be attempted for a particular amount of times before the automated teller machine session is terminated. For example, the user may only have two (2) attempts at identity verification using the one-time password before the automated teller machine is terminated.

As described herein, identity verification using a one-time password may be implemented as a second factor authentication mechanism during an automated teller machine session, activated only when the automated teller machine session is determined to be high risk. The one-time password provides an additional layer of security by requiring the user to verify their identity through a trusted communication channel, such as SMS, email, or push notification.

Furthermore, the one-time password is time-sensitive, with a short expiration window, thereby significantly reducing the opportunity for fraudulent exploitation. The one-time password is uniquely associated with a specific automated teller machine session, ensuring that only the authenticated user is able to proceed with the automated teller machine session. This automated teller machine session-specific association of the one-time password mitigates risks arising from physical card cloning or skimming attacks.

Still further, by integrating one-time password-based authentication into automated teller machine sessions, transaction security is significantly enhanced. Additionally, the use of one-time passwords provides users with a real-time notification of an active automated teller machine session on their account, enabling them to promptly identify unauthorized activity and terminate the automated teller machine session if fraud is suspected.

As mentioned, in response to determining that the automated teller machine session is high risk, the server computer system 130 may initiate second factor authentication. In one or more embodiments, the second factor authentication may include verifying identity using in-app biometric authentication.

In-app biometric authentication may include verifying a user's identity using biometric data such as for example fingerprints, facial recognition, or iris scans, performed directly within a mobile application. Biometric authentication leverages biometric hardware and software capabilities of a mobile device (such as the mobile device 150) such as for example a fingerprint scanner or facial recognition camera, integrated with a mobile applications secure authentication flow. During in-app biometric authentication, the mobile application interfaces with the mobile device's operating system or biometric API to capture, encrypt, and validate biometric data. In-app biometric authentication may include matching the user's live biometric input against encrypted biometric templates securely stored on the mobile device. In response to successful in-app biometric authentication, the mobile device grants access to the mobile application. The mobile device may generate at least one signal that includes a signed session token or authentication response and may send the at least one signal to a server associated with the mobile application confirming that the user has been authenticated through biometric means. The mobile device may also send within the at least one signal data that includes metadata such as a timestamp, device identifier, or session information to ensure the authentication event is logged and can be correlated with a session on the server side.

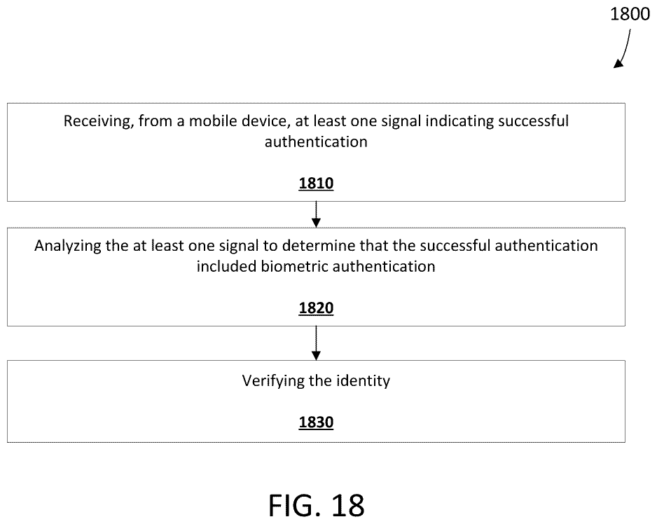

The server computer system 130 may authenticate the automated teller machine session when it is determined that in-app biometric authentication is successful. Reference is made to FIG. 18, which illustrates, in flowchart form, a method 1800 for identity verification using in-app biometric authentication. The method 1800 may be implemented by a computing device having suitable processor-executable instructions for causing the computing device to carry out the described operations. The method 1800 may be implemented, in whole or in part, by the server computer system 130. At least some of the operations may be offloaded to the automated teller machine 110.

The method 1800 includes receiving, from a mobile device, at least one signal indicating successful authentication (step 1810).

In one or more embodiments, the at least one signal may be transmitted by the mobile device (such as the mobile device 150) in response to successful authentication performed within a specific mobile application residing on the mobile device. The specific mobile application may be hosted, maintained, or associated with the server computing system 130.

In certain embodiments, the at least one signal may include a log entry transmitted to a centralized activity log system managed by the server computing system 130. In these embodiments, the server computing system 130 may either periodically poll or subscribe to updates from the activity log system to detect authentication events. Upon identifying a log entry that indicates successful authentication, the server computing system 130 determines that authentication has been successfully performed. It will be appreciated that the at least one signal may include data or metadata that includes an identifier of the mobile device (such as the mobile device 150) that may have been generated during an application installation and set up process. The identifier may uniquely associate the mobile device with the application instance, enabling secure linkage between the mobile device and subsequent authentication events.

In one or more embodiments, the at least one signal may comprise data elements indicative of the authentication method utilized and associated metadata. Such metadata may include, but is not limited to, a timestamp of the authentication event, the unique identifier of the mobile device, and details of the application instance where authentication occurred.

The method 1800 further includes analyzing the at least one signal to determine that the successful authentication included biometric authentication (step 1820).

As described previously, the at least one signal may include data specifying the authentication method and related metadata. Using this information, the server computing system 130 can perform an analysis to determine whether biometric authentication was utilized. For example, the signal may include a field such as “authentication_method: biometric”, which explicitly identifies the method.

Responsive to determining that the successful authentication included biometric authentication, verify the identity (step 1830).

In response to confirming successful in-app biometric authentication, the server computing system 130 verifies the identity.

It will be appreciated that the server computer system 130 may perform one or more additional operations to verify the identity such as for example validating the integrity of the received at least one signal, ensuring that it originated from an authorized source, and mapping the authenticated user to a corresponding identity record in the server's database.

Responsive to verifying the identity using in-app biometric authentication, the server computer system 130 authorizes at least one function. For example, as mentioned, the at least one function may include initiating the automated teller machine session and as such the server computer system 130 may send at least one signal to the automated teller machine 110 indicating that the automated teller machine session is initiated. As another example, the at least one function may include authorizing a transaction requested during the automated teller machine session and as such the server computer system 130 and/or the automated teller machine 110 may perform operations to complete the requested transaction (withdrawal, transfer, etc.). As one example, the automated teller machine 110 may dispense money as requested during the automated teller machine session in response to successful identity verification.

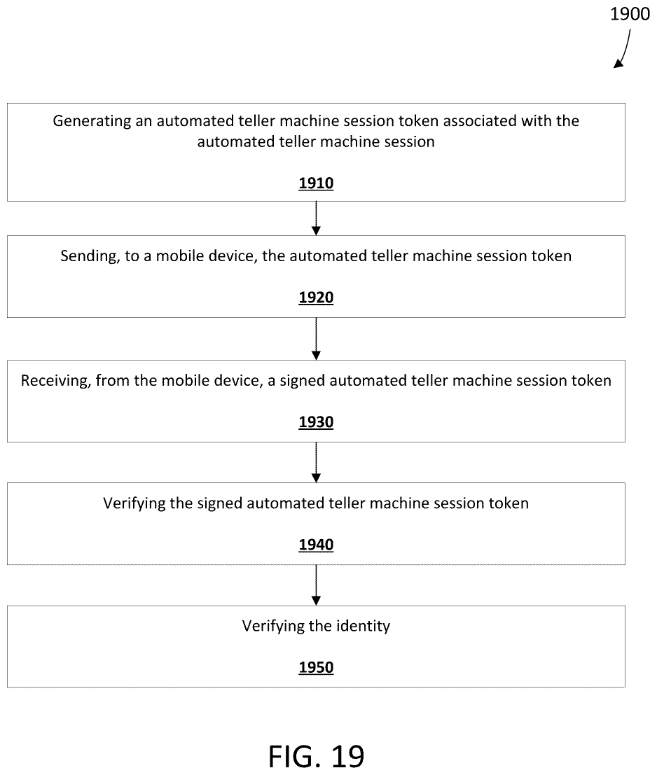

In one or more embodiments, the server computer system 130 may utilize an automated teller machine session token that may be used to authenticate the automated teller machine session using in-app biometric authentication. Reference is made to FIG. 19, which illustrates, in flowchart form, another method 1900 for identity verification using in-app biometric authentication. The method 1900 may be implemented by a computing device having suitable processor-executable instructions for causing the computing device to carry out the described operations. The method 1900 may be implemented, in whole or in part, by the server computer system 130. At least some of the operations may be offloaded to the automated teller machine 110.

The method 1900 includes generating an automated teller machine session token associated with the automated teller machine session (step 1910).

Upon initiation of the automated teller machine session, such as for example in response to first factor authentication using chip and PIN, the server computer system 130 may generate a unique automated teller machine session token. The unique automated teller machine session token may be cryptographically secure and time-limited to prevent misuse.

The unique automated teller machine session token is associated with the automated teller machine session linking it to the user and transaction details such as for example the automated teller machine session start time.

At the time the automated teller machine session is initiated, the server computer system 130 may perform operations to identify the user and/or account being accessed. For example, during the first factor authentication using chip and PIN, the server computer system 130 may identify the account being accessed and may retrieve account details. The server computer system 130 may also retrieve a mobile device identifier that may have been obtained or generated during a mobile application installation and configuration process. The mobile device identifier may include a device identifier, mobile number, email address, etc.

In one or more embodiments, the server computer system 130 may associate the automated teller machine session token with the mobile device identifier.

The method 1900 includes sending, to a mobile device, the automated teller machine session token (step 1920).

Once the automated teller machine session token has been generated, the server computer system 130 may send the automated teller machine session token to the mobile device (such as the mobile device 150) using the mobile device identifier. In one or more embodiments, the server computer system 130 may send the automated teller machine session token to the mobile device using a secure communication channel such as for example a push notification service or directly via an API call to the mobile application on the mobile device.

The mobile device receives the automated teller machine session token and may store it in a secure storage location such as for example a keychain or encrypted storage.

The method 1900 includes receiving, from the mobile device, at least one signal that includes a signed automated teller machine session token (step 1930).

The user may authenticate through biometric or other means on the mobile device (such as the mobile device 150) to access the mobile application and in response the mobile application may sign the automated teller machine session token using a private key. The private key may be part of a public/private key pair that is generated during a configuration or installation process of the mobile application. The private key is stored securely on the mobile device and may be used for signing data. The public key is generated by the mobile device and sent to the server computer system 130. The public key is stored by the server computer system 130 and may be used to verify the authenticity of signed data.

The mobile device sends at least one signal to the server computer system 130 that includes the signed automated teller machine session token and this may be done using a secure protocol.

The method 1900 includes verifying the signed automated teller machine session token (step 1940).

The server computer system 130 may verify the signed automated teller machine session token using the corresponding public key to validate the signature. For example, the server computer system 130 may check the cryptographic has included in the signature against the payload of the token to ensure data integrity.

It will be appreciated that if the verification process is successful, the server computer system 130 confidently associates the signed automated teller machine session token with the corresponding automated teller machine session, ensuring that the authentication was legitimate and that the token was signed by the trusted mobile device.

In one or more embodiments, to verify the automated teller machine session token, the server computer system 130 may perform additional operations to determine that biometric authentication was used. For example, the server computer system 130 may analyze the signed automated teller machine session token to determine the authentication method used. In this example, the automated teller machine session token may include metadata that identifies the authentication method used. The server computer system 130 may determine that the authentication method used includes biometric authentication and in response, may verify the signed automated teller machine session token.

Responsive to verifying the signed automated teller machine session token, the method 1900 includes verifying the identity (step 1950).

Upon successful verification of the signed automated teller machine session token, the server computer system 130 may verify the identity.

Responsive to verifying the identity using in-app biometric authentication, the server computer system 130 authorizes at least one function. For example, as mentioned, the at least one function may include initiating the automated teller machine session and as such the server computer system 130 may send at least one signal to the automated teller machine 110 indicating that the automated teller machine session is initiated. As another example, the at least one function may include authorizing a transaction requested during the automated teller machine session and as such the server computer system 130 and/or the automated teller machine 110 may perform operations to complete the requested transaction (withdrawal, transfer, etc.). As one example, the automated teller machine 110 may dispense money as requested during the automated teller machine session in response to successful identity verification.

As described herein, identity verification using in-app biometric authentication may be implemented as a second factor authentication mechanism during an automated teller machine session only when the automated teller machine session is determined to be high risk.

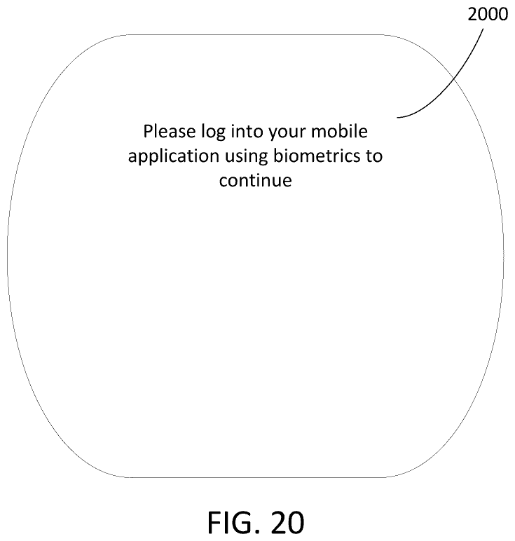

In one or more embodiments described herein where identity verification is performed using in-app biometric authentication, the server computer system 130 may send at least one signal to the automated teller machine causing the automated teller machine to display a notification requesting in-app biometric authentication. An example notification 2000 is shown in FIG. 20. The notification 2000 is displayed on a display screen of an automated teller machine and includes a request to log into the mobile application using biometrics.

It will be appreciated that in one or more embodiments the server computer system 130 may additionally send a request to log into the mobile application to the mobile device (such as the mobile device 150). For example, the server computer system 130 may send an SMS message, an email message, or a push notification that includes a request to log into the mobile application and this may be done in manners similar to that described herein. The request may include an option to deny the request and confirm fraud. For example, the request may include a selectable option to deny the request and confirm fraud or may include information requesting that the user reply to the message with ‘FRAUD’ in manners similar to that described herein.

In manners described herein, in-app biometric authentication as a second factor authentication mechanism increases security of high risk automated teller machine sessions. For example, by leveraging biometric data stored on a mobile device, such as fingerprints or facial recognition, the systems and methods described herein add a robust layer of protection beyond traditional chip and PIN methods. Even if an attacker gains access to a user's chip and PIN, the attacker cannot complete a transaction without successfully authenticating using biometric data on the user's mobile device, making unauthorized access much more difficult. This reduces the risk of theft and ensures that authentication is device-specific, tying each automated teller machine session directly to the user's trusted mobile device.

Further, the integration of biometric authentication provides a seamless highly secure method for automated teller machine session approval. For example, a user may authenticate quickly via their mobile devices without needing to remember or input additional credentials at the automated teller machine. Further, in-app biometric authentication increases privacy as biometric data remains securely stored on the mobile device and is never transmitted to or stored at the automated teller machine.

In at least some embodiments described herein, the use of automated teller machine session tokens ensures that only authorized users are able to complete transactions initiated at the automated teller machine, adding an additional layer of security. The use of automated teller machine session tokens leverages biometric sensors on mobile devices and reduces the need for expensive biometric scanners at automated teller machines. By ensuring that authentication data is device-bound and reducing the need for additional hardware, embodiments described herein streamline the authentication process and makes it easier to scale across automated teller machine systems.

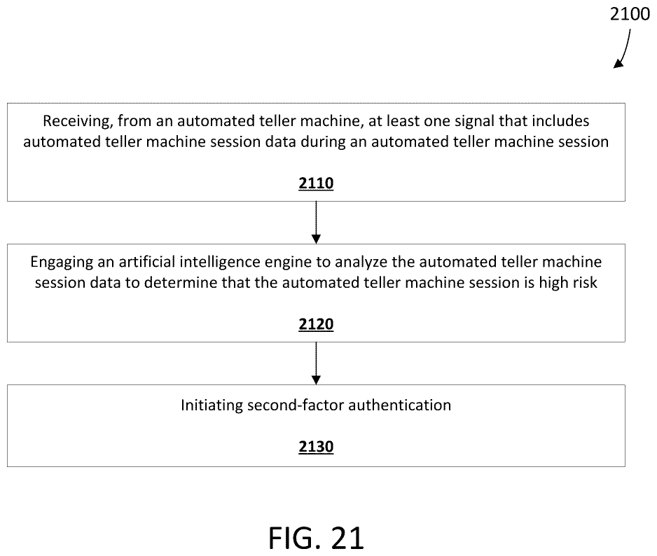

As described herein, the server computer system 130 may engage the artificial intelligence engine 600 to determine that an automated teller machine session is high risk. Reference is made to FIG. 21, which illustrates, in flowchart form, a method 2100 for initiating second factor authentication. The method 2100 may be implemented by a computing device having suitable processor-executable instructions for causing the computing device to carry out the described operations. The method 2100 may be implemented, in whole or in part, by the server computer system 130. At least some of the operations may be offloaded to the automated teller machine 110.

The method 2100 includes receiving, from an automated teller machine, at least one signal that includes automated teller machine session data during an automated teller machine session (step 2110).

Step 21110 may be performed in manners similar to that described herein such as for example as described with reference to step 710 of the method 700.

The method 2100 includes engaging an artificial intelligence engine to analyze the automated teller machine session data to determine that the automated teller machine session is high risk (step 2120).

The artificial intelligence engine may include the artificial intelligence engine 600 described herein. For example, the automated teller machine session data may be provided as input and the artificial intelligence engine 600 may analyze the automated teller machine session data to generate a risk score or classify the automated teller machine session as high risk or low risk.

As described herein, the artificial intelligence engine 600 may classify the automated teller machine session as high risk based on transaction specific and real-time features such as unusual withdrawal patterns, transaction timing, or anomalies in user behavior (e.g. card usage far from the customer's normal location). This classification is determined at least partially based on the automated teller machine session data.

Additionally, through use of the artificial intelligence engine 600, an automated teller machine session initiated at an automated teller machine classified as high risk may not necessarily be classified as high risk if transaction patterns and user behavior appear normal and don't match typical fraud signals. However, automated teller machines classified as high risk may have a higher likelihood of hosting high risk automated teller machine sessions due to their environment. Conversely, an automated teller machine session may be classified as high risk by the artificial intelligence engine 600 even if it is initiated at an automated teller machine classified as low risk.

The method 2100 includes initiating second factor authentication (step 2130).

Responsive to determining that the automated teller machine session is high risk, the server computer system 130 may initiate second factor authentication. The server computer system 130 may initiate the second factor authentication automatically and in response to determining that the automated teller machine session is high risk. For example, at least one function may be requested during the automated teller machine session that may deem the automated teller machine session high risk and as such second factor authentication may be required to authorize the at least one function. In this example, the at least one function may include initiating the automated teller machine session or authorizing a transaction requested during the automated teller machine session.

It will be appreciated that in one or more embodiments, the artificial intelligence engine 600 may additionally be trained to select a type of second factor authentication to authenticate the automated teller machine session. For example, the second factor authentication may include one of image-based biometric authentication, one-time password authentication, or in-app biometric authentication. The artificial intelligence engine 600 may be trained to select one of the second factor authentication methods based on a combination of risk assessment and contextual data.

Once trained, the artificial intelligence engine 600 may include a dynamic second factor recommendation system that leverages contextual data and advanced analytics to enhance security. The artificial intelligence engine 600 may integrate the three distinct second factor authentication methods-image-based biometric authentication, one-time password authentication, and in-app biometric authentication-into an artificial intelligence-driven decision engine. The artificial intelligence engine 600 is trained to analyze automated teller machine session data and situational data, such as user behavior, geolocation, automated teller machine location, transaction type, device capabilities, and historical patterns, to determine the most appropriate second factor authentication method for each automated teller machine session. By tailoring the second factor authentication method to the specific context and risk profile, the artificial intelligence engine 600 mitigates potential security threats while optimizing the user experience.

In one or more embodiments, the artificial intelligence engine 600 may select a particular second factor authentication method based on a risk score for the automated teller machine session (also determined by the artificial intelligence engine). For example, as described herein, the artificial intelligence engine 600 may assess risk factors such as unusual withdrawal patterns, the location of the automated teller machine in relation to the user's typical usage history, transaction amount, or time of day. If these factors indicate elevated risk, the artificial intelligence engine 600 may initiate second factor authentication and dynamically select the most suitable second factor authentication method.

The second factor authentication method may be selected at least based on the specific context. For example, image-based biometric authentication may be selected only if an imaging device is available and functional to capture the image data. Similarly, in-app biometric authentication may only be selected if the user has installed the mobile application on their device and has previously performed in-app biometric authentication. As yet another example, one-time password authentication may only be selected if a digital address, such as a verified mobile phone number or email address, is available in the database. It will be appreciated that the database may be consulted to determine one or more context features, such as device compatibility or user preferences.

In one or more embodiments, if one or more of the second factor authentication methods are available based on the specific context, the second factor authentication method may be selected at least based on a risk score. For instance, image-based biometric authentication or in-app biometric authentication may be selected when the risk score is between 0.9-1.0, as these methods are generally more secure. Conversely, one-time password authentication may be selected when the risk score is between 0.8-0.9 to balance security and efficiency.

In one or more embodiments, if multiple second factor authentication methods are available based on the specific context, the artificial intelligence engine 600 may prioritize the selection of a second factor authentication method based on resource efficiency. For example, image-based biometric authentication may require greater computing resources than one-time password authentication. Therefore, when both methods are viable, the artificial intelligence engine 600 may select one-time password authentication to conserve resources while maintaining sufficient security for the risk level.

To support this functionality, the artificial intelligence engine 600 may rely on a training dataset that includes historical automated teller machine session data, labeled risk scores, environmental conditions, and authentication outcomes. The engine may be trained using supervised learning techniques to identify patterns and optimize the selection of second factor authentication methods. Additionally, reinforcement learning may be employed to refine the engine's decision-making over time, ensuring continuous adaptation to emerging threats and changing user behaviors. This approach ensures that the artificial intelligence engine 600 remains robust, flexible, and effective in securing automated teller machine sessions.

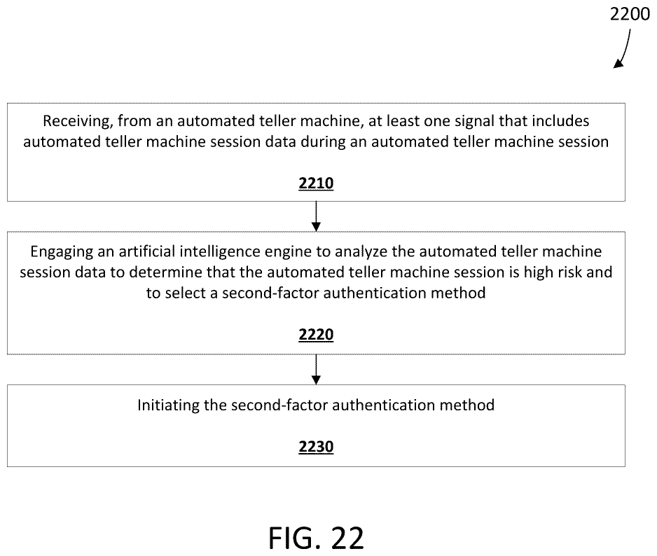

The server computer system 130 may engage the artificial intelligence engine 600 to determine that an automated teller machine session is high risk and to select a second factor authentication method. Reference is made to FIG. 22, which illustrates, in flowchart form, a method 2200 for initiating second factor authentication. The method 2200 may be implemented by a computing device having suitable processor-executable instructions for causing the computing device to carry out the described operations. The method 2200 may be implemented, in whole or in part, by the server computer system 130. At least some of the operations may be offloaded to the automated teller machine 110.

The method 2200 includes receiving, from an automated teller machine, at least one signal that includes automated teller machine session data during an automated teller machine session (step 2210).

Step 2210 may be performed in manners similar to that described herein such as for example as described with reference to step 710 of the method 700.

The method 2200 includes engaging an artificial intelligence engine to analyze the automated teller machine session data to determine that the automated teller machine session is high risk and to select the second factor authentication method (step 2220).

The server computer system 130 may engage the artificial intelligence engine 600 to analyze the automated teller machine session data to determine that the automated teller machine session is high risk in manners similar to that described herein such as for example during step 2120 of the method 2100.

The server computer system 130 may engage the artificial intelligence engine 600 to analyze the automated teller machine session data to select the second factor authentication method. For example, as mentioned, in one or more embodiments, the artificial intelligence engine 600 may select a particular second factor authentication method based on the risk score for the automated teller machine session. For example, as described herein, the artificial intelligence engine 600 may assess risk factors such as unusual withdrawal patterns, the location of the automated teller machine in relation to the user's typical usage history, transaction amount, or time of day. If these factors indicate elevated risk, the artificial intelligence engine 600 may initiate second factor authentication and dynamically select the most suitable second factor authentication method.

The second factor authentication method may be selected at least based on the specific context. For example, image-based biometric authentication may be selected only if an imaging device is available and functional to capture the image data. Similarly, in-app biometric authentication may only be selected if the user has installed the mobile application on their device and has previously performed in-app biometric authentication. As yet another example, one-time password authentication may only be selected if a digital address, such as a verified mobile phone number or email address, is available in the database. It will be appreciated that the database may be consulted to determine one or more context features, such as device compatibility or user preferences.

In one or more embodiments, if one or more of the second factor authentication methods are available based on the specific context, the second factor authentication method may be selected at least based on a risk score. For instance, image-based biometric authentication or in-app biometric authentication may be selected when the risk score is between 0.9-1.0, as these methods are generally more secure. Conversely, one-time password authentication may be selected when the risk score is between 0.8-0.9 to balance security and efficiency.

In one or more embodiments, if multiple second factor authentication methods are available based on the specific context, the artificial intelligence engine 600 may prioritize the selection of a second factor authentication method based on resource efficiency. For example, image-based biometric authentication may require greater computing resources than one-time password authentication. Therefore, when both methods are viable, the artificial intelligence engine 600 may select one-time password authentication to conserve resources while maintaining sufficient security for the risk level.

Responsive to determining that the automated teller machine session is high risk and selecting a second factor authentication method, the method 2200 includes initiating the second factor authentication method (step 2230).

Responsive to determining that the automated teller machine session is high risk, the server computer system 130 may initiate the second factor authentication. The server computer system 130 may initiate the second factor authentication automatically. For example, at least one function may be requested during the automated teller machine session that may deem the automated teller machine session high risk and as such second factor authentication may be required to authorize the at least one function. In this example, the at least one function may include initiating the automated teller machine session or authorizing a transaction requested during the automated teller machine session.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

1. A computer system comprising:
a communications module;
at least one processor coupled with the communications module; and
a memory coupled to the at least one processor and storing processor-executable instructions which, when executed by the at least one processor, configure the at least one processor to:
receive, via the communications module and from an automated teller machine, at least one signal that includes automated teller machine session data during an automated teller machine session;
generate, based on the automated teller machine session data, a risk indication for the automated teller machine session;
determine, based on the risk indication, that the automated teller machine session is high risk; and
responsive to determining that the automated teller machine session is high risk, initiate authentication of the automated teller machine session using one-time password authentication.

2. The computer system of claim 1, wherein the instructions, when executed, further configure the at least one processor to:
responsive to authenticating the automated teller machine session using the one-time password authentication, authorize at least one function during the automated teller machine session.

3. The computer system of claim 2, wherein the at least one function includes initiating the automated teller machine session or authorizing a transaction requested during the automated teller machine session.

4. The computer system of claim 1, wherein when initiating the authentication of the automated teller machine using the one-time password authentication, the instructions, when executed, further configure the at least one processor to:
generate a one-time password and associate the one-time password with the automated teller machine session.

5. The computer system of claim 4, wherein when initiating the authentication of the automated teller machine using the one-time password authentication, the instructions, when executed, further configure the at least one processor to:
determine, based at least on the automated teller machine session data, a digital address; and
send, via the communications module and to the digital address, at least one signal that includes the one-time password.

6. The computer system of claim 5, wherein the one-time password is sent to the digital address via one of short message service message, electronic mail, or push notification.

7. The computer system of claim 1, wherein when initiating the authentication of the automated teller machine using the one-time password authentication, the instructions, when executed, further configure the at least one processor to:
send, via the communications module and to the automated teller machine, at least one signal causing the automated teller machine to display a message prompting input of a one-time password;
receive, via the communications module and from the automated teller machine, at least one signal that includes a password entered using a keypad associated with the automated teller machine; and
compare the password to the one-time password to authenticate the automated teller machine session.

8. The computer system of claim 1, wherein the authentication of the automated teller machine using the one-time password authentication is performed as a second factor authentication during the automated teller machine session only when the automated teller machine session is determined to be high risk based on the generated risk score.

9. The computer system of claim 1, wherein when generating the risk indication, the instructions, when executed by the at least one processor, further configure the at least one processor to:
analyze the automated teller machine session data at least to determine that the automated teller machine is located in an area known to be high risk.

10. The computer system of claim 1, wherein when generating the risk indication, the instructions, when executed by the at least one processor, further configure the at least one processor to:
analyze the automated teller machine session data at least to identify an automated teller machine risk score indicating that the automated teller machine is high risk.

11. The computer system of claim 1, wherein when generating the risk indication, the instructions, when executed by the at least one processor, further configure the at least one processor to:
analyze the automated teller machine session data at least to determine that a time of the automated teller machine session is high risk.

12. The computer system of claim 1, wherein when determining that the automated teller machine session is high risk, the instructions, when executed by the at least one processor, further configure the at least one processor to:
analyze the automated teller machine session data at least to identify a withdrawal amount requested during the automated teller machine session.

13. The computer system of claim 1, wherein the instructions, when executed, further configure the at least one processor to:
engage an artificial intelligence engine to analyze the automated teller machine session data to generate the risk indication.

14. A computer-implemented method comprising:
receiving, via a communications module and from an automated teller machine, at least one signal that includes automated teller machine session data during an automated teller machine session;
generating, based on the automated teller machine session data, a risk indication for the automated teller machine session;
determining, based on the risk indication, that the automated teller machine session is high risk; and
responsive to determining that the automated teller machine session is high risk, initiating authentication of the automated teller machine session using one-time password authentication.

15. The computer-implemented method of claim 14, further comprising:
responsive to authenticating the automated teller machine session using the one-time password authentication, authorizing at least one function during the automated teller machine session.

16. The computer-implemented method of claim 15, wherein the at least one function includes initiating the automated teller machine session or authorizing a transaction requested during the automated teller machine session.

17. The computer-implemented method of claim 14, wherein when initiating the authentication of the automated teller machine session using the one-time password authentication, the method further comprises:
generating a one-time password and associating the one-time password with the automated teller machine session.

18. The computer-implemented method of claim 17, wherein when initiating the authentication of the automated teller machine session using the one-time password authentication, the method further comprises:
determining, based at least on the automated teller machine session data, a digital address; and
sending, via the communications module and to the digital address, at least one signal that includes the one-time password.

19. The computer-implemented method of claim 14, wherein when initiating the authentication of the automated teller machine session using the one-time password authentication, the method further comprises:
sending, via the communications module and to the automated teller machine, at least one signal causing the automated teller machine to display a message prompting input of a one-time password;
receiving, via the communications module and from the automated teller machine, at least one signal that includes a password entered using a keypad associated with the automated teller machine; and
comparing the password to the one-time password to authenticate the automated teller machine session.

20. A non-transitory computer readable storage medium comprising computer-executable instructions which, when executed, configure at least one processor to:
receive, via a communications module and from an automated teller machine, at least one signal that includes automated teller machine session data during an automated teller machine session;
generate, based on the automated teller machine session data, a risk indication for the automated teller machine session;
determine, based on the risk indication, that the automated teller machine session is high risk; and
responsive to determining that the automated teller machine session is high risk, initiate authentication of the automated teller machine session using one-time password authentication.
